(19) United States
(12) Patent Application Publication
(10) Pub. No.: US 2026/0267892 A1
(43) Pub. Date: Sep. 10, 2026

(54) System and Method for Curvature-Regulated Persistent Cognitive Machines

(71) Applicant: AtomBeam Technologies Inc., Moraga, CA (US)

(72) Inventors: Brian Galvin, Silverdale, WA (US); Alan McCord, Forney, TX (US)

(21) Appl. No.: 19/458,660

(22) Filed: Jan. 23, 2026

Related U.S. Application Data
(63) Continuation-in-part of application No. 19/382,207, filed on Nov. 6, 2025, now Pat. No. 12,688,217.
Application No. 19/382,207 is a continuation of application No. 19/203,069, filed on Jun. 3, 2025, now Pat. No. 12,481,688.
Application No. 19/203,069 is a continuation-in-part of application No. 19/205,960, filed on May 12, 2025.
Application No. 19/205,960 is a continuation-in-part of application No. 19/060,794, filed on Feb. 24, 2025.
Application No. 19/060,794 is a continuation-in-part of application No. 19/044,546, filed on Feb. 3, 2025.
Application No. 19/044,546 is a continuation-in-part of application No. 19/026,276, filed on Jan. 16, 2025.
Application No. 19/026,276 is a continuation-in-part of application No. 18/928,022, filed on Oct. 26, 2024.
Application No. 18/919,417 is a continuation-in-part of application No. 18/918,077, filed on Oct. 17, 2024.
Application No. 18/928,022 is a continuation-in-part of application No. 18/919,417, filed on Oct. 17, 2024, now Pat. No. 12,602,586.
Application No. 18/918,077 is a continuation-in-part of application No. 18/737,906, filed on Jun. 7, 2024.
Application No. 18/918,077 is a continuation-in-part of application No. 18/736,498, filed on Jun. 6, 2024.
(60) Provisional application No. 63/651,359, filed on May 23, 2024.

(51) Int. Cl. G06F 16/334; G06F 11/1446; G06F 16/3329; G06F 16/353; G06F 18/2137; G06N 3/049; G06N 3/06

(52) U.S. Cl. CPC G06F 16/3347; G06F 11/1446; G06F 16/3329; G06F 16/353; G06F 18/21375; G06N 3/049; G06N 3/061

(57) ABSTRACT

A system and method for persistent machine cognition that maintains continuous awareness across inactive periods and system restarts. The system organizes thoughts as vector embeddings within a latent-space data structure and monitors both external inputs and internally generated thought triggers. Relevant thoughts are retrieved using similarity metrics computed within the latent space to inform cognitive output generation. The system computes curvature metrics that represent deviation or distortion measures derived from distance or similarity computations associated with stored thoughts. Compressed representations derived from these curvature metrics are stored in reservoir data structures. During processor-executed maintenance modes, the system transfers curvature-derived data between the thought cache and the reservoirs. Cognitive continuity is maintained by persisting the thought cache along with reservoir data structures and associated state data sufficient to restore the complete cognitive state upon restart.

### CROSS-REFERENCE TO RELATED APPLICATIONS

Priority is claimed in the application data sheet to the following patents or patent applications, each of which is expressly incorporated herein by reference in its entirety:

19/382,207

19/203,069

19/205,960

19/060,794

19/044,546

19/026,276

18/928,022

18/919,417

18/918,077

18/737,906

18/736,498

63/651,359

### BACKGROUND OF THE INVENTION

### Field of the Art

The present invention relates to the field of computer-implemented cognitive architectures, and more specifically to systems and methods for maintaining and regulating persistent machine cognition using curvature-derived computational invariants and reservoir-based memory structures.

### Discussion of the State of the Art

Artificial intelligence systems in widespread use today, including large language models and reasoning-augmented transformers, generally operate within a prompt-response paradigm. These systems remain inactive until prompted, perform inference only over the context supplied at runtime, and lose all intermediate cognitive structure once the inference cycle is complete. Although such models have demonstrated impressive performance in natural language processing, code generation, and problem solving, their cognitive capabilities are fundamentally bounded by the lack of persistent internal state and by a reliance on dense numerical optimization rather than structured, memory-aware reasoning.

Efforts to extend these models with external memory stores, retrieval-augmented pipelines, or chain-of-thought mechanisms have partially improved their reasoning ability but do not confer persistent cognition. These systems do not maintain a long-lived cognitive state, cannot autonomously reorganize their internal structures, and cannot learn continuously across inactive periods. They also lack mechanisms to regulate the complexity or stability of their internal representations, making long-term operation increasingly costly and brittle as memory size grows.

The Persistent Cognitive Machine (PCM), disclosed in the parent application, introduced a shift away from single-shot inference toward a system capable of maintaining cognitive continuity across sessions. The PCM stores thoughts as vector embeddings in a thought cache, performs sleep-state maintenance on those stored thoughts, and restores its cognitive state after restart. Despite these advancements, the PCM’s latent-space organization remains essentially static, and the system has no means of regulating constraint density within its embedding structures. It lacks a mechanism for systematically compressing, abstracting, or redistributing representational complexity. In the absence of such mechanisms, persistent systems may accumulate structural tension, redundancy, or contradiction within memory representations, leading to degraded performance or escalating computational demands over time.

Existing approaches also provide no general-purpose method for forming, maintaining, or leveraging global invariants that summarize structural information accumulated through reasoning. Modern reasoning systems do not track loop-derived structural patterns, do not extract abstract invariants from repeated inference cycles, and do not employ compressed representations that can be injected back into memory to stabilize or reorganize cognitive structures. Likewise, current systems do not dynamically manage or reorganize cognitive subspaces in response to observed representational complexity.

What is needed is a computer-implemented cognitive architecture that maintains persistent thought representations, detects and quantifies structural distortions within its latent space, transfers curvature-derived information into compressed reservoir structures, stabilizes inference through loop-derived invariants, dynamically manages cognitive subspaces based on representational complexity, and preserves these enriched cognitive structures across inactive periods and system restarts.

### SUMMARY OF THE INVENTION

Accordingly, the inventor has conceived and reduced to practice improvements to a persistent cognitive system by integrating curvature-regulated reasoning mechanisms, reservoir-based invariant storage, and holonomy-derived structural updates into a digital thought architecture. These improvements enable a machine to sustain and evolve a cognitive state across inactive periods through continuous memory organization, curvature-aware information processing, and exchange flows that regulate constraint density within a latent-space data structure. The disclosed system uses computer-executable routines to compute curvature metrics, maintain compressed structural representations in reservoir data structures, stabilize loop-derived invariants, dynamically manage sector topologies in memory, and persist all cognitive state required to restore continuity of cognition upon restart.

In an embodiment, a computer system initializes a persistent cognitive state capable of surviving inactive periods, organizing thought representations as vector embeddings in a latent-space data structure, and monitoring both external stimuli and internal cognitive triggers. The system identifies relevant stored thoughts based on similarity metrics computed within the latent space and uses them to guide generative or analytical model outputs. The system produces new thoughts from analysis of incoming events and stores them as vector representations. The system computes curvature metrics representing distortions or deviations between different distance or similarity measures in one or more regions of the latent space, stores compressed representations derived from those curvature metrics in one or more reservoir data structures, enters maintenance modes during which curvature-derived information flows between the reservoirs and the thought cache, and persists sufficient cognitive state data—including at least the thought cache and reservoir structures—to maintain continuity of cognition across system restarts.

In an aspect of an embodiment, the system detects cyclic inference sequences within the latent-space data structure and computes loop-derived invariants representing accumulated structural information from each sequence, stores those invariants in a holonomy register, and uses them to influence subsequent retrieval or cognitive output generation.

In an aspect of an embodiment, the reservoir data structures include multiple reservoir types, each configured to store compressed representations associated with a corresponding category of curvature-derived information, and the system directs curvature-derived data to a selected reservoir according to a classification of the curvature metric.

In an aspect of an embodiment, the system dynamically manages cognitive sectors that represent logical partitions of the latent-space data structure by creating sectors in response to curvature accumulation, federating sectors in response to detected correlation, or dissolving sectors after curvature has been absorbed by a reservoir.

In an aspect of an embodiment, the system injects compressed representations from one or more reservoir data structures into the thought cache to augment or reorganize portions of the latent-space data structure, either during maintenance modes or in response to contextual conditions during cognitive processing.

In an aspect of an embodiment, the system stabilizes or consolidates loop-derived invariants during cognitive maintenance modes and preserves the holonomy register as part of the persistent state so that loop-derived invariants are restored after restart.

In an aspect of an embodiment, the persistent state further includes topology metadata describing boundaries and relationships among cognitive sectors to ensure that sector organization is restored following restart.

In an aspect of an embodiment, the system computes curvature metrics using a constant or near-constant number of distance or similarity evaluations regardless of latent-space size and performs reservoir updates as constant-size operations.

In an aspect of an embodiment, the reservoirs include structures configured to store compressed representations associated with conceptual conflict, structural redundancy, or novel or under-constrained regions of the latent-space data structure.

The corresponding method embodiments operate in accordance with the same functional principles as the computer-system embodiments described above, and their features apply equally without requiring separate restatement herein.

### BRIEF DESCRIPTION OF THE DRAWING FIGURES

FIG. 1 illustrates an exemplary system architecture of a persistent cognitive machine incorporating generalized curvature exchange dynamics.

FIG. 2 illustrates an exemplary architecture of an executive core configured to coordinate cognitive activity and curvature exchange operations.

FIG. 3 illustrates an exemplary architecture of a thought cache organized as a latent-space memory structure with sector-aware components.

FIG. 4 illustrates an exemplary architecture of a curvature detection engine configured to compute and classify curvature metrics within a latent space.

FIG. 5 illustrates an exemplary architecture of a holonomy engine configured to derive, update, and maintain loop-based structural invariants.

FIG. 6 illustrates an exemplary architecture of a reservoir array configured to store and inject compressed curvature-derived invariants.

FIG. 7 illustrates an exemplary architecture of a sector manager configured to create, federate, and dissolve cognitive sectors.

FIG. 8 illustrates an exemplary architecture of a sleep manager configured to perform curvature-regulated maintenance operations.

FIG. 9 illustrates an exemplary architecture of a persistence layer configured to serialize and restore cognitive state information.

FIG. 10 illustrates an exemplary method for primary cognitive processing including thought retrieval, output generation, curvature evaluation, and state persistence.

FIG. 11 illustrates an exemplary method for curvature computation and curvature exchange flow within a latent-space data structure.

FIG. 12 illustrates an exemplary method for holonomy accumulation derived from cyclic inference sequences.

FIG. 13 illustrates an exemplary method for curvature-regulated cognitive maintenance during a processor-executed maintenance state.

FIG. 14 illustrates an exemplary method for dynamic sector topology management based on curvature, correlation, and holonomy conditions.

FIG. 15 illustrates an exemplary computing environment on which an embodiment described herein may be implemented.

### DETAILED DESCRIPTION OF THE INVENTION

The inventor has conceived and reduced to practice a system and method of implementing persistent machine cognition using a digital thought architecture that incorporates curvature-regulated reasoning, reservoir-based storage of compressed structural information, holonomy accumulation, and dynamic management of cognitive sectors within a latent-space data structure. Such a system maintains a persistent cognitive state across inactive intervals, computes curvature-based structural indicators from stored thought representations, transfers curvature-derived information into compressed reservoir structures, stabilizes loop-derived invariants, reorganizes latent-space topology according to representational conditions, and restores enriched cognitive state information following system restart.

In an embodiment, a system includes an executive core configured to coordinate cognitive activity. An executive core observes internal and external events, evaluates such events in relation to stored thoughts and operational context, and determines when to retrieve stored thoughts or generate new thoughts. An executive core directs reasoning operations, manages transitions between interactive and maintenance-oriented cognitive conditions, and allocates resources among components supporting language operations, analytical reasoning, thought-handling processes, curvature evaluation, reservoir management, holonomy consolidation, and persistence operations.

In an embodiment, a system includes a thought cache that stores thought representations as vector embeddings within a latent-space data structure. A thought cache includes a short-term region in which recently accessed or newly formed thoughts are maintained and a long-term region for persistent knowledge that informs future cognition. A latent-space data structure organizes embeddings so that similar thoughts are positioned near one another based on similarity metrics. A semantic network records explicit logical, temporal, causal, or referential relationships between thought representations. A curvature map records curvature values derived from comparison of distance or similarity measures within selected regions of a latent space, thereby identifying areas of conceptual compression, contradiction, redundancy, or novelty.

In an embodiment, a latent-space data structure is treated as a manifold-like organizational domain upon which distances or similarity measures can be computed. A curvature metric is derived from deviation between at least two such measures. For example, in an embodiment, curvature K(x, y) is computed as a difference between a geodesic distance d(x, y) and a linearized or expected distance d_lin(x, y), expressed as K(x, y) = d(x, y) − d_lin(x, y). Such an expression is provided for non-limiting illustration; curvature proxies may be computed using alternative distortion, density, or deviation measures. Curvature evaluation is performed using a constant or near-constant number of similarity computations, enabling a curvature-handling process to detect curvature efficiently without scaling with a total number of stored thought representations. This constant-time update behavior extends to holonomy updates and reservoir updates, where each invariant update is implemented using a fixed number of arithmetic operations irrespective of latent-space size. As a result, computation of curvature, holonomy, or reservoir invariants proceeds in constant or near-constant computational time, supporting efficient growth of a cognitive system.

In an embodiment, a curvature-handling process evaluates curvature within one or more latent-space regions. A curvature-handling process identifies curvature values, interprets such values in relation to stored context, and determines whether curvature exceeds one or more thresholds. Curvature classification distinguishes between structural categories such as conceptual conflict, representational noise, redundancy patterns, or novel under-constrained regions. Such classification can be performed using rule-based criteria, similarity of distortion patterns, magnitude thresholds, sign indicators, or learned decision functions, and classification outcomes govern how curvature-derived representations are processed downstream.

In an embodiment, a system incorporates one or more reservoir data structures that store compressed invariant representations derived at least in part from curvature-related information. A reservoir receives curvature-derived representations, compresses such representations into a low-dimensional invariant structure, and updates its stored content using constant-size update rules. Multiple reservoirs can exist within a system, each oriented toward a type of structural representation, such as abstractions, alignment cues, procedural structures, or generative associations. Reservoir content is available for reintegration into a latent-space data structure and supports reorganization or enrichment of stored cognitive content through injection operations. Injection of reservoir representations into a latent space can modify similarity patterns, reduce curvature in high-tension regions, introduce new abstraction templates, reshape local or regional curvature landscapes, or influence subsequent geodesic or retrieval behavior by restructuring representational geometry.

In an embodiment, a system incorporates holonomy accumulation as part of its reasoning behavior. A holonomy-handling process observes inference trajectories and identifies cycles in which a cognitive state returns to a previously encountered representational region. When a loop is detected, a holonomy-handling process computes a loop-derived invariant representing a displacement between an expected return state and an observed return state. Such an invariant may be stored in a holonomy register using additive, multiplicative, decaying, or reinforcing update strategies. Holonomy values influence future reasoning and retrieval by embedding structural priors derived from past cognitive cycles and enabling stable long-range inference patterns.

In an embodiment, a system manages cognitive sectors that partition a latent-space data structure into coherent representational regions. A sector-management process creates a new cognitive sector when curvature accumulates in a region, federates sectors when correlation or holonomy similarity suggests shared structure, and dissolves sectors when representational tension has been resolved through curvature transfer. Sector boundaries are adjustable, and a boundary-handling process shifts boundaries according to curvature flow directions, similarity changes, or activity distribution. Thought representations can transfer between sectors when representational context changes, and overlapping sector boundaries can be resolved by comparing curvature magnitudes, holonomy relationships, or similarity criteria. Sector boundaries and relationships are recorded in a sector registry, enabling restoration of sector topology after a restart.

In an embodiment, a system performs internal cognitive maintenance during periods of reduced external responsiveness. Maintenance includes consolidation of short-term thoughts into long-term storage, generalization of specific experiences into broader concepts, generation of insights through recombination of stored thoughts, and pruning of low-relevance information. Maintenance further includes curvature pumping in which curvature-derived data is transferred from active regions of a latent space into reservoir structures, stabilization of holonomy values within a holonomy register, injection of reservoir representations back into a latent space to reorganize or simplify representational geometry, and adjustment of sector topology to reflect updated representational structure.

In an embodiment, a system preserves its cognitive state by persisting thought cache content, reservoir content, curvature maps, holonomy registers, and sector topology metadata to non-volatile storage. Persistence routines serialize such data structures into durable formats, and restoration routines reconstruct latent-space organization, repopulate embeddings, restore reservoir invariants, reestablish sector boundaries, and reinstate holonomy values after restart. This persistence behavior enables a system to maintain continuity of cognition across inactive intervals and subsequent activation cycles.

In an embodiment, a system generates cognitive outputs by integrating external stimuli, stored experience, reservoir-provided representations, holonomy-derived structural priors, and current representational conditions. Retrieval routines select relevant thoughts using similarity metrics, curvature assessments, sector membership, and holonomy signals. Generative or analytical processes operate on retrieved thoughts and present stimuli to produce cognitive outputs that reflect stored knowledge, reorganized representational structure, and accumulated invariants.

Various implementations can include alternative curvature metrics, different compression strategies for reservoir representations, alternative holonomy update rules, distinct sector formation and dissolution strategies, alternative latent-space embedding models, and varied persistence approaches. These implementations remain consistent with a persistent cognitive system that computes curvature metrics, stores compressed invariants, accumulates loop-derived structure, dynamically organizes cognitive sectors, performs curvature-regulated maintenance, and restores cognitive state across inactive intervals.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “persistent cognitive system” refers to a computer-implemented cognitive architecture that maintains an internal cognitive state across inactive intervals and system restarts, including stored thoughts, structural information, and configuration state.

As used herein, “thought” refers to a machine-generated or machine-stored representation of information, concept, inference, question, or cognitive content, stored in any computable form including vector embeddings, symbolic patterns, or structured data representations.

As used herein, “thought cache” refers to a computer-readable memory structure configured to store thoughts in short-term and long-term regions, using vector embeddings or other representations organized within a latent-space data structure.

As used herein, “latent-space data structure” refers to any machine-readable arrangement of vector embeddings, similarity metrics, or organizational geometry that positions stored thoughts in a multi-dimensional computational space, including structures that emulate manifold-like or graph-like behavior.

As used herein, “similarity metric” refers to any computable comparison between two or more thought representations, including but not limited to vector distance, cosine similarity, geodesic approximation, or other functional measures of representational proximity.

As used herein, “curvature metric” refers to any computable distortion or deviation measure associated with one or more regions of a latent-space data structure, such as a comparison of a geodesic distance and a linearized or expected distance, or any measure reflecting representational tension, redundancy, contradiction, or novelty.

As used herein, “curvature-derived data” refers to any machine-processed representation generated from a curvature metric, including compressed invariants, classification labels, structural summaries, or any computationally derived information based in part on curvature evaluation.

As used herein, “reservoir data structure” refers to a computer-readable data structure configured to receive, compress, store, and provide invariant representations derived from curvature metrics or other structural signals.

As used herein, “invariant representation” refers to a compressed computational structure that summarizes information extracted from curvature metrics, loop-derived patterns, sector activity, or other signals, and that is stored or utilized independently of the specific thought representations from which it originated.

As used herein, “reservoir injection” refers to a process in which invariant representations stored within a reservoir data structure are introduced into a latent-space data structure in order to reorganize, augment, or reshape portions of that structure.

As used herein, “holonomy” refers to a loop-derived invariant that represents a difference between an expected cognitive return state and an observed cognitive return state after traversal of a cyclic inference sequence within a latent-space data structure.

As used herein, “holonomy register” refers to a computer-readable data structure used to store one or more holonomy values, including additive, multiplicative, decayed, or reinforced invariants derived from cyclic inference processing.

As used herein, “cognitive sector” refers to a logical subdivision of a latent-space data structure that groups a set of thought representations according to similarity, curvature behavior, activity patterns, or representational correlations.

As used herein, “sector topology” refers to metadata describing boundaries, relationships, parent-child structures, or federated groupings of cognitive sectors within a latent-space data structure.

As used herein, “sector creation,” “sector federation,” and “sector dissolution” refer to processes by which a system allocates new sectors, merges existing sectors, or removes sectors in response to curvature conditions, representational correlations, holonomy similarities, or activity patterns.

As used herein, “curvature pumping” refers to a process during which curvature-derived data is transferred from regions of a latent-space data structure into one or more reservoir data structures.

As used herein, “cognitive maintenance mode” refers to a processor-executed operational condition in which external responsiveness is reduced and internal reorganization operations occur, including memory consolidation, generalization, pruning, curvature pumping, reservoir injection, holonomy stabilization, and sector topology adjustments.

As used herein, “persistent state” refers to any collection of data structures serialized to non-volatile storage to enable reconstruction of a persistent cognitive system’s condition following restart, including but not limited to thought cache content, reservoir content, curvature maps, holonomy registers, and sector topology metadata.

As used herein, “geodesic distance” refers to any computed or estimated path-based similarity or distance measure between thought representations within a latent-space data structure, whether exact or approximate.

As used herein, “linearized distance” refers to an expected or approximated similarity or distance measure used as a baseline for curvature determination in contrast to a geodesic or manifold-aware metric.

As used herein, “loop-derived invariant” refers to any computable structural summary extracted from cyclical inference activity, including holonomy values or any other constant-size representation derived from repeated reasoning patterns.

As used herein, “thought trigger internal to the persistent cognitive system” refers to any system-generated event or signal that initiates cognitive processing without external input, including curvature threshold events indicating that a curvature metric has exceeded a configured value, holonomy update events indicating completion of a cyclic inference sequence, sector topology events indicating creation, federation, or dissolution of cognitive sectors, reservoir injection events indicating availability of compressed invariants for reintegration, and maintenance scheduling events indicating satisfaction of conditions for entering a cognitive maintenance mode.

### Conceptual Architecture

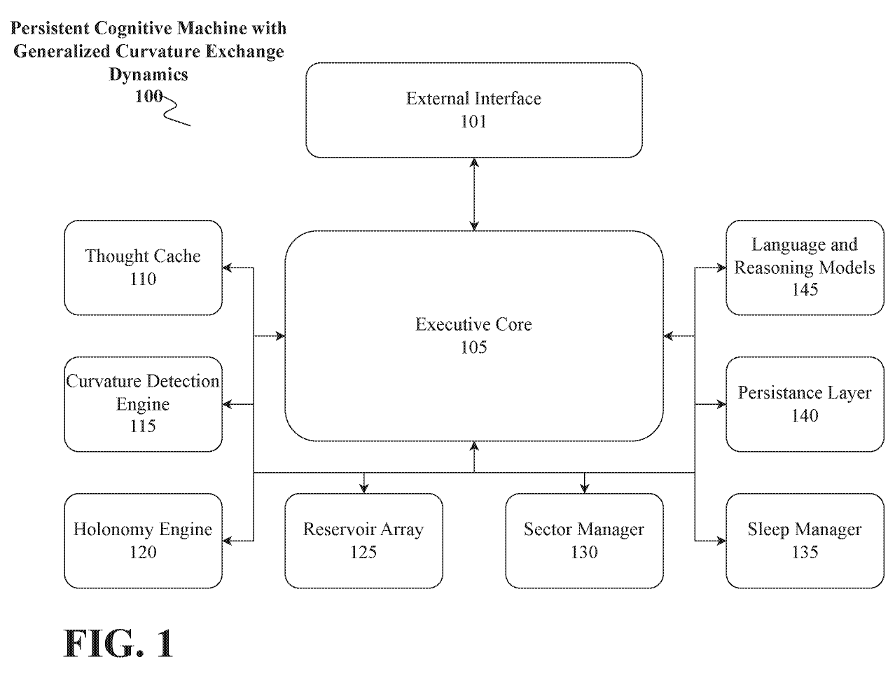

FIG. 1 is a block diagram illustrating an exemplary architecture of a Persistent Cognitive Machine (PCM) with generalized curvature exchange dynamics 100, in an embodiment. System 100 is configured to maintain a persistent cognitive state across inactive intervals and system restarts by organizing thought representations as vector embeddings within a latent-space data structure, computing curvature-based distortion metrics, routing curvature-derived data into compressed reservoir structures, and restoring system state upon reactivation. As shown, system 100 includes an external interface 101 through which stimuli such as user inputs, API calls, or document submissions are received, and through which cognitive outputs are transmitted. System 100 further includes an executive core with curvature-exchange controller 105, a thought cache with manifold structure 110, a curvature detection engine 115, a holonomy engine 120, a reservoir array 125, a sector manager 130, a sleep manager with curvature-regulated maintenance 135, a persistence layer 140, and one or more language and reasoning models 145.

In some embodiments, executive core 105 operates as an orchestration subsystem that coordinates cognitive processes, evaluates incoming stimuli, and directs data flow between other components based on system state and curvature signals. The executive core monitors curvature metrics reported by the curvature detection engine 115, receives loop-derived invariants from the holonomy engine 120, and regulates transitions between active cognitive states and maintenance states in cooperation with sleep manager 135. A curvature-exchange controller within executive core 105 executes routing logic to classify and transfer curvature-derived data to one or more reservoirs, and initiates reservoir injection operations when structural augmentation of the latent-space data structure is appropriate.

In an embodiment, thought cache 110 serves as a persistent memory structure that organizes thought representations as vector embeddings within a latent-space data structure. The thought cache includes short-term and long-term storage regions and maintains sector-aware indexing to support retrieval, curvature mapping, and similarity analysis. It may also store a curvature map overlay associating regions of the manifold with distortion metrics, and a sector registry describing sector boundaries, relationships, and metadata. The thought cache interfaces with executive core 105, reservoir array 125, and language and reasoning models 145 to support continuity of thought and curvature-aware memory access.

In some implementations, language and reasoning models 145 may serve as cognitive engines that process combinations of retrieved thoughts and external stimuli to generate new thought representations and cognitive outputs. These models operate under the control of executive core 105 and exchange data with the thought cache 110. Outputs may be transmitted externally via interface 101 or stored internally as new thought embeddings. Iterative retrieval, generation, and evaluation cycles may be guided by structural signals such as curvature or holonomy.

To analyze representational distortion, curvature detection engine 115 executes algorithms that compute curvature metrics based on deviations between multiple similarity or distance measures. For example, in some embodiments, curvature may be defined as the difference between a geodesic distance and a linearized baseline distance. The engine applies configurable thresholds to curvature values and emits events to executive core 105 when distortion exceeds such thresholds. Sparse geodesic probes may be used to ensure that curvature detection executes in constant or near-constant time regardless of latent-space size.

In an embodiment, holonomy engine 120 derives compact structural invariants by identifying cyclic inference trajectories and computing loop-derived displacements. These displacements represent differences between expected and actual return states in the latent space and are stored as fixed-size vectors or matrices in a holonomy register. Update rules may include additive, multiplicative, or decay-based strategies. Holonomy signals may inform retrieval weighting, structural biasing, or inference stabilization within the broader system.

Reservoir array 125 may include a set of software-defined memory modules that store compressed invariant representations derived from curvature metrics. Each reservoir may specialize in a type of representational condition, such as abstraction, redundancy, alignment, or novelty. Curvature-derived data is routed to appropriate reservoirs based on classification and compressed using projection routines. Stored invariants may be injected back into the thought cache 110 to reshape similarity relationships or reduce constraint density in the manifold. Projection and injection operations are designed to execute as constant-size updates.

In certain embodiments, sector manager 130 dynamically organizes the latent-space data structure by managing the creation, federation, and dissolution of cognitive sectors. Sector creation may be triggered by localized curvature accumulation, while federation may result from correlation or holonomy similarity across sectors. Dissolution may occur when curvature has been absorbed or redistributed. The sector manager updates the sector registry accordingly, and the thought cache 110 adjusts sector membership of stored thoughts without requiring large-scale data migration.

During periods of reduced responsiveness, sleep manager 135 coordinates curvature-regulated maintenance routines. These routines may include consolidation of short-term memories, pruning of low-relevance content, generalization, curvature pumping to reservoirs, holonomy stabilization, sector topology adjustments, and reservoir injection into the latent space. Sleep manager 135 may determine entry and exit conditions for maintenance states based on activity levels, curvature load, or elapsed runtime, and signals executive core 105 to resume active cognition when conditions are met.

In an embodiment, persistence layer 140 supports continuity of cognition by serializing cognitive state structures—including thought cache content, curvature maps, holonomy registers, reservoir data, and sector registry metadata—to non-volatile storage. Full or incremental snapshots may be created at configurable intervals. Upon system restart, persistence layer 140 restores the serialized state into the corresponding runtime structures, enabling the system to resume operation with enriched memory and reasoning structures intact.

In an exemplary operation, system 100 receives an external input through interface 101, which is processed by executive core 105 to determine cognitive relevance and appropriate response strategy. The thought cache 110 is queried for relevant embeddings using similarity and sector-aware criteria. Language and reasoning models 145 generate a response based on retrieved thoughts and current stimuli. New thoughts are embedded and stored, potentially altering local curvature in the manifold. Curvature detection engine 115 evaluates the affected region and, if thresholds are exceeded, curvature-exchange controller routes metrics to reservoir array 125 for compression. During a maintenance cycle coordinated by sleep manager 135, compressed invariants may be injected back into the thought cache to reshape structural relationships. Holonomy engine 120 may register inference loops and update its stored invariants. Persistence layer 140 serializes the full state to support continuity on the next system cycle.

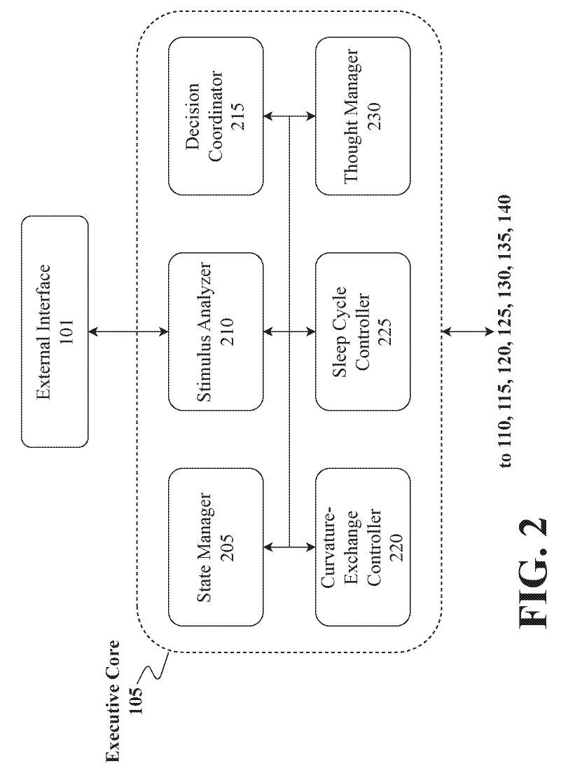

FIG. 2 is a block diagram illustrating an exemplary architecture of an executive core with curvature-exchange controller 105, in an embodiment. Within system 100, executive core 105 operates as a coordination hub for managing cognitive activity, system state transitions, and curvature exchange flows between the latent-space manifold and reservoir structures.

In the illustrated embodiment, executive core 105 includes a state manager 205, stimulus analyzer 210, decision coordinator 215, curvature-exchange controller 220, sleep cycle controller 225, and thought manager 230. These subcomponents function collectively to process stimuli, allocate system resources, initiate retrieval and storage operations, and regulate transitions between active and maintenance-oriented modes of operation.

State manager 205 maintains real-time awareness of the PCM system's operational condition, distinguishing between active interaction, passive observation, independent cognition, and sleep states. It monitors transitions between these states and communicates current state information to decision coordinator 215. When maintenance is initiated or completed, state manager 205 receives transition directives from sleep cycle controller 225. This operational context informs subsystem activation and guides how resources are distributed across the system during each cognitive phase.

Stimulus analyzer 210 processes both external and internal stimuli, including user inputs, API calls, document submissions, system-internal thought triggers, and curvature threshold events. It performs computational assessments such as intent recognition, content classification, priority scoring, and curvature relevance evaluation. Results of this analysis are encapsulated in stimulus reports transmitted to decision coordinator 215, where they contribute to downstream decision logic.

Decision coordinator 215 integrates signals from state manager 205, stimulus analyzer 210, curvature-exchange controller 220, and holonomy engine 120 to determine appropriate system actions. It selects operational pathways such as invoking retrieval routines, initiating curvature exchange, activating generative or reasoning models 145, or modifying cognitive sector topology. Decision coordinator 215 also issues execution directives to thought manager 230 and curvature-exchange controller 220, aligning subsystem behavior with current cognitive goals and curvature conditions.

Curvature-exchange controller 220 monitors curvature signals across the latent-space manifold and coordinates data transfer between high-curvature regions and reservoir structures. When threshold conditions are detected, it applies classification logic to identify curvature types—such as conflict, redundancy, novelty, or noise—and routes curvature-derived data to a corresponding reservoir within reservoir array 125. In addition to managing projection flows, curvature-exchange controller 220 may trigger injection operations, during which compressed reservoir content is reintroduced into relevant manifold regions. Curvature status information is shared with decision coordinator 215 to support adaptive control decisions.

Sleep cycle controller 225 evaluates the system’s readiness for maintenance-mode entry by tracking factors such as cumulative activity, curvature buildup, resource usage, and elapsed time since the prior cycle. When conditions warrant, it signals state manager 205 to initiate sleep state transitions. During the maintenance period, sleep cycle controller 225 synchronizes operations with sleep manager 135 to coordinate curvature pumping, reservoir consolidation, holonomy stabilization, and sector topology optimization. It also monitors for wake triggers—such as external input or curvature resolution—and signals reactivation when appropriate.

Thought manager 230 executes memory operations within system 100 by managing the retrieval and storage of thought representations. It interfaces with thought cache 110 to store new thoughts generated by language or reasoning models 145 and to retrieve existing thoughts based on contextual relevance, curvature features, and holonomy-guided retrieval biases. Thought manager 230 follows control signals from decision coordinator 215 and may apply diverse retrieval strategies, including those based on semantic similarity, sector membership, analogical mapping, or reservoir-derived associations. Retrieved thoughts are delivered to generative models for output production, while newly generated thoughts are written to memory and made available for curvature and holonomy processing.

In an embodiment, data flow through executive core 105 begins when external stimuli, such as user inputs, API calls, or document submissions, are received via interface 101 and passed to stimulus analyzer 210. Internal stimuli, such as curvature threshold events from curvature detection engine 115 or loop closures identified by holonomy engine 120, are also received by stimulus analyzer 210 or directly reported to decision coordinator 215. Stimulus analyzer 210 generates analysis reports that include intent, priority, and curvature relevance scores, and transmits them to decision coordinator 215, which simultaneously receives state data from state manager 205 and curvature classification signals from curvature-exchange controller 220. Holonomy engine 120 may supply loop-derived invariants used to bias retrieval or inform sector-level decisions.

Based on these inputs, decision coordinator 215 determines an appropriate system response and orchestrates data flow accordingly. If thought retrieval is warranted, it instructs thought manager 230 to query thought cache 110 using context-aware strategies that incorporate curvature maps, holonomy values, and sector membership. If generative or analytical processing is required, decision coordinator 215 activates language or reasoning models 145 and delivers retrieved thoughts for processing. In response to curvature events, decision coordinator 215 may direct curvature-exchange controller 220 to initiate projection of curvature-derived metrics into reservoir array 125 or to trigger injection of compressed invariants back into relevant manifold regions.

Executive core 105 also interacts with sector manager 130 to manage cognitive topology, directing creation, federation, or dissolution of sectors when representational or curvature dynamics exceed configured thresholds. During maintenance-mode entry, sleep cycle controller 225 signals state manager 205 to initiate a transition, and coordinates with sleep manager 135 to execute curvature pumping, holonomy consolidation, reservoir injection, and sector topology optimization. Throughout these operations, executive core 105 maintains synchronized coordination across all active subsystems, ensuring consistent execution of curvature-regulated cognition and continuity of system function.

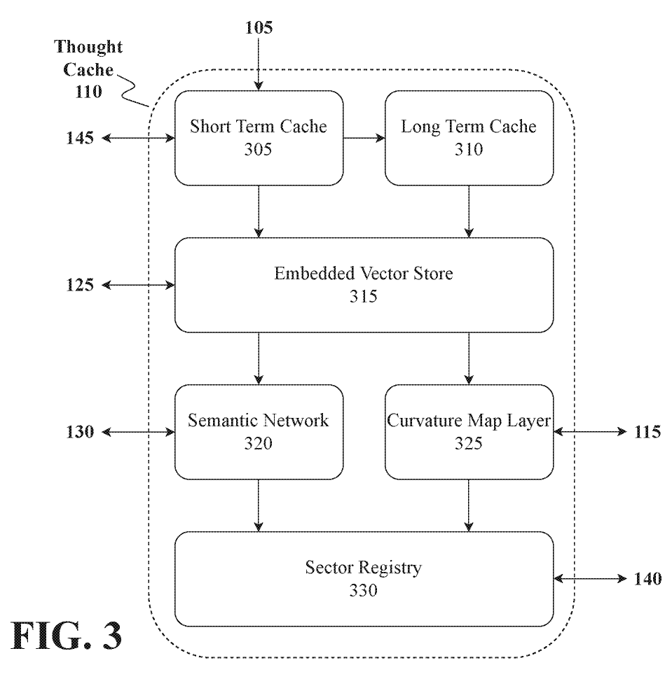

FIG. 3 is a block diagram illustrating an exemplary architecture of a thought cache with manifold structure 110, in an embodiment. Within system 100, thought cache 110 operates as a persistent memory structure that stores thought representations as vector embeddings organized within a latent-space data structure. This memory architecture supports similarity-based retrieval, curvature-aware processing, and sector-based partitioning of cognitive content. As illustrated, thought cache 110 comprises a short-term cache 305, long-term cache 310, embedded vector store 315, semantic network 320, curvature map layer 325, and sector registry 330. These components operate in coordination to store and organize thoughts, compute and record curvature metrics, maintain logical relationships, and support retrieval processes guided by structural and contextual features.

Short-term cache 305 temporarily retains recently encountered or newly generated thoughts for immediate access during active cognitive operations. It receives new thought representations from executive core 105 and provides those representations to language and reasoning models 145 during response generation. As thoughts accrue relevance through frequency, impact, or structural contribution, they may be promoted from short-term cache 305 to long-term cache 310. Thought entries in short-term cache 305 are indexed with respect to cognitive sector membership, using metadata provided by sector registry 330 to align with broader memory topology.

Long-term cache 310 maintains a persistent repository of cognitive content, including accumulated experiences and derived knowledge. It supports retrieval operations during both active and maintenance cycles and serves as the substrate for structural invariants such as holonomy. Transfers from short-term to long-term memory are guided by criteria including repetition, relevance, and contribution to curvature or loop-based structure. Memory contents in long-term cache 310 are organized into discrete cognitive sectors, with explicit boundary definitions maintained in sector registry 330 to support partitioned access and sector-aware retrieval.

Embedded vector store 315 transforms thought content into vector embeddings positioned within a high-dimensional latent space. This data structure supports multiple embedding models and may maintain heterogeneous vector spaces to accommodate diverse content types. Thought embeddings are positioned using configurable similarity metrics, and geodesic approximations may be used to support curvature evaluation and routing decisions. Embedded vector store 315 receives input from both memory caches and acts as a shared substrate for retrieval, similarity computation, and manifold navigation.

Semantic network 320 captures explicit relationships between thoughts that may not be fully represented in the vector space. These include causal, hierarchical, temporal, contradictory, and co-membership relationships. In some embodiments, semantic network 320 incorporates metadata derived from curvature metrics—such as indicators of high constraint density or conceptual tension—sourced from curvature map layer 325. This network augments retrieval by enabling access to related thoughts even when vector similarity is low, supporting more robust reasoning and generative operations.

Curvature map layer 325 records distortion metrics computed across the latent-space manifold. It stores sparse mappings between thought pairs or manifold regions and their associated curvature values, as computed by curvature detection engine 115. The layer is incrementally updated as new thoughts are added, existing thoughts are retrieved, or manifold structure evolves. Stored curvature metrics are accessible to both semantic network 320 and curvature detection engine 115 for threshold evaluation, historical trend analysis, or real-time inference regulation.

Sector registry 330 maintains metadata describing the structure and boundaries of cognitive sectors within the latent space. It tracks sector types (e.g., local, federated), parent-child relationships, federation links, and dynamic boundary definitions that influence how thoughts are grouped and accessed. Updates from sector manager 130 are recorded in the registry when sectors are created, merged, or dissolved. Sector registry 330 also interfaces with persistence layer 140 to serialize sector topology for restoration after system restart, ensuring continuity of structural memory.

In an embodiment, data flows through thought cache 110 as follows: when new cognitive content is generated—either in response to external stimuli or internal inference—executive core 105 transmits the new thought to short-term cache 305. Upon receipt, the system assigns the thought to one or more cognitive sectors using criteria such as semantic similarity, representational proximity, and local curvature conditions. Embedded vector store 315 transforms the incoming thought into a high-dimensional vector embedding and integrates it into the latent-space manifold. As a result of this insertion, curvature map layer 325 is updated to reflect any distortion introduced by the new vector, using curvature metrics computed by curvature detection engine 115. If the curvature impact exceeds configured thresholds, the executive core may initiate curvature exchange operations that route curvature-derived data into reservoir array 125.

Simultaneously, semantic network 320 evaluates the new thought’s relationships to existing content, recording logical, temporal, hierarchical, or contradictory connections and enriching the system’s structural representation. As the system continues operation, short-term cache 305 provides fast-access memory for active thoughts used in generative or analytical processes. When certain promotion criteria are met—such as frequency of use, contribution to holonomy, or structural significance—thoughts are transferred to long-term cache 310 and incorporated into the persistent memory structure. Throughout this process, sector registry 330 ensures that each thought’s sector membership is maintained and updated, particularly in response to topology changes issued by sector manager 130.

In some cases, invariant structures previously stored in reservoir array 125 may be reinjected into embedded vector store 315, either during curvature-regulated maintenance or as part of a contextual enrichment process. These injections may alter local similarity relationships, resolve representational tension, or propagate abstraction motifs into the active manifold. Updated curvature metrics and sector assignments are forwarded to persistence layer 140, which serializes the memory state for restoration after system restart. This continual interaction among caches, vector stores, semantic networks, curvature maps, and sector metadata allows thought cache 110 to serve as a dynamic, curvature-aware memory substrate supporting persistent machine cognition.

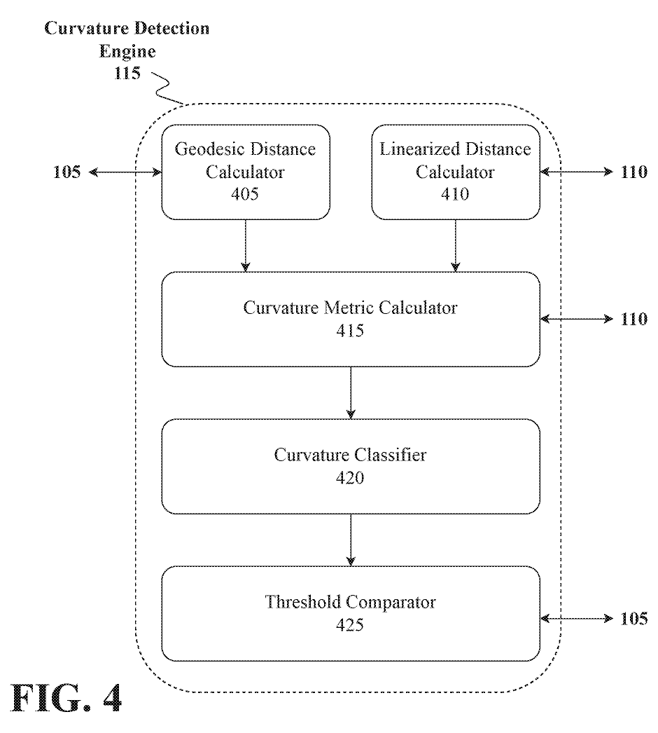

FIG. 4 is a block diagram illustrating an exemplary architecture of a curvature detection engine 115, in an embodiment. Within system 100, curvature detection engine 115 operates as a processor-executed subsystem configured to generate curvature-related computational signals that characterize structural conditions present within regions of the latent-space data structure. These signals provide indicators of representational tension, constraint density, redundancy, and novelty, and they inform decisions carried out by executive core 105 regarding memory organization, sector topology, and reservoir exchange flows. Curvature detection engine 115 receives evaluation requests from curvature-exchange controller 220 along with thought-vector data from thought cache 110, and produces curvature values, curvature classifications, and threshold events that guide downstream processing within a PCM.

As illustrated, curvature detection engine 115 comprises a geodesic distance estimation component 405, a linearized distance estimation component 410, a curvature-derivation component 415, a curvature-classification component 420, and a threshold-evaluation component 425. These components cooperate to estimate intrinsic distance measures, compute baseline linearized distances, derive curvature proxy values representing distortion within the manifold, assign structural categories that describe the observed distortion, and determine whether curvature conditions warrant further action elsewhere in system 100.

In an embodiment, geodesic distance estimation component 405 receives either thought-vector pairs or manifold-region identifiers and computes approximations of intrinsic path-based distances between the associated thought embeddings. The component may employ sparse geodesic probing techniques using limited waypoint sampling or local graph traversal so that geodesic distance estimation requires a substantially constant number of operations independent of overall latent-space size. Geodesic estimation component 405 produces distance values d(x, y) and transmits them to curvature-derivation component 415 for further processing.

Linearized distance estimation component 410 operates concurrently with geodesic estimation component 405 and computes expected or baseline distances corresponding to the same set of inputs. In various embodiments, linearized distances may be derived using Euclidean metrics, tangent-plane projections, or other local approximations that serve as reference values for curvature assessment. By computing linearized and geodesic distances in parallel, the curvature detection engine reduces latency and supports real-time generation of curvature indicators during both active cognition and maintenance conditions. Linearized distance estimation component 410 produces reference values d_lin(x, y), which are also transmitted to curvature-derivation component 415.

Curvature-derivation component 415 receives the intrinsic distance values from geodesic estimation component 405 and the baseline values from linearized distance estimation component 410 and derives a curvature proxy that reflects the deviation between the two measures. In an embodiment, curvature-derivation component 415 computes curvature using K(x, y) = d(x, y) − d_lin(x, y) as a non-limiting example. Other embodiments may compute curvature using density-based distortion values, graph-structural deviation metrics, or normalized discrepancy measures that capture representational distortion within the manifold. Curvature-derivation component 415 transmits derived curvature values to curvature-classification component 420 and records such values in curvature map layer 325 of thought cache 110 for historical reference during future processing cycles.

Curvature-classification component 420 analyzes curvature values and assigns a structural category associated with the representational condition producing the distortion. Classification logic may evaluate magnitude, sign, temporal behavior, relationship to local manifold density, or correspondence with previously observed distortion signatures. In an embodiment, classification categories include conflict curvature indicating incompatibilities in conceptual structure, noise curvature associated with unstable or irrelevant associations, redundancy curvature associated with repeated or overconstrained representational patterns, and novelty curvature associated with sparse or under-constrained manifold regions. Curvature-classification component 420 forwards its classification to threshold-evaluation component 425 for decision-making regarding downstream actions.

Threshold-evaluation component 425 receives the classified curvature information and determines whether the curvature condition satisfies one or more operational thresholds configured within curvature-exchange controller 220 or associated subsystems. Threshold comparison may consider absolute magnitude, recent curvature trends, sector-specific boundaries, or learned parameters representing expected curvature ranges within different regions of the manifold. When curvature values satisfy or exceed one or more thresholds, threshold-evaluation component 425 produces a curvature-threshold event transmitted to curvature-exchange controller 220. These events may lead to reservoir projection operations within reservoir array 125, sector topology adjustments executed by sector manager 130, or maintenance-scheduling updates performed by sleep manager 135.

In an embodiment, data flows through curvature detection engine 115 as follows. Curvature-exchange controller 220 issues an assessment request specifying a thought pair or manifold region requiring curvature evaluation. Thought cache 110 provides the corresponding vector embeddings, which are supplied to geodesic distance estimation component 405 and linearized distance estimation component 410. Each component computes its respective measure from the same input to ensure consistent evaluation of manifold structure. Curvature-derivation component 415 receives both computed values and derives a curvature metric representing the observed distortion. The derived curvature is delivered to curvature map layer 325 and to curvature-classification component 420, which assigns a structural category suitable for downstream cognitive regulation. Threshold-evaluation component 425 analyzes the classified curvature and determines whether the curvature condition warrants a system-level response. If so, curvature-threshold events are transmitted to curvature-exchange controller 220, which may route curvature-derived representations into one or more reservoir structures, initiate reservoir-based injections into the manifold, or request sector-level reorganization. This cooperative design enables curvature detection engine 115 to provide real-time, constant-cost structural indicators that support curvature-regulated reasoning, dynamic memory organization, and persistent cognitive stability within a PCM.

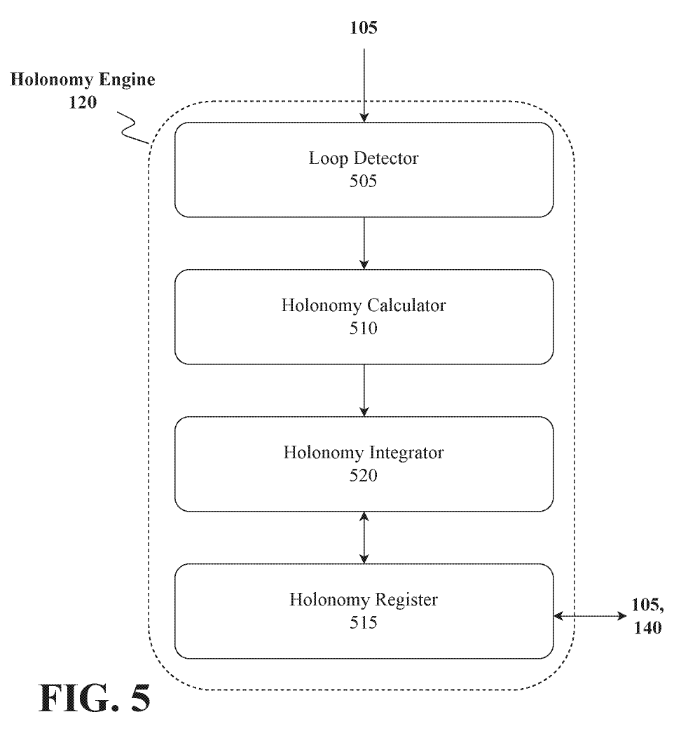

FIG. 5 is a block diagram illustrating an exemplary architecture of a holonomy engine 120, in an embodiment. Within system 100, holonomy engine 120 operates as a processor-executed subsystem configured to derive, accumulate, and maintain loop-derived invariants representing structural information associated with cyclic inference activity in the latent-space data structure. Holonomy values characterize the displacement between an expected cognitive return state and an observed return state after traversal of an inference loop. These displacement values function as compact structural priors that assist the system in stabilizing long-range inference, shaping retrieval behavior, and informing representational decisions made by executive core 105. Holonomy engine 120 receives inference trajectory information from thought manager 230 and the executive core, and produces updated holonomy values that remain accessible across cognitive cycles.

As illustrated, holonomy engine 120 comprises a loop detector 505, a holonomy calculator 510, a holonomy register 515, and a holonomy integrator 520. These components cooperate to identify cyclic patterns in system activity, derive displacement vectors capturing structural effects associated with each detected loop, store the resulting invariants in persistent form, and apply configurable update operations that regulate how new contributions influence accumulated holonomy state.

In an embodiment, loop detector 505 observes inference trajectories reported by thought manager 230 and executive core 105. As reasoning proceeds, loop detector 505 receives a sequence of embedded representations and evaluates the evolving trajectory against proximity criteria that determine whether the system has returned to a previously visited representational region. When the proximity criteria indicate a return condition, loop detector 505 identifies a loop closure event. It then extracts a loop specification that includes a representation of the starting region, a description of the intermediate trajectory, and a record of the endpoint representation from which a displacement will be computed. This specification is transmitted to holonomy calculator 510 for further analysis.

Holonomy calculator 510 receives the loop specification and derives a displacement value that captures the structural information accumulated during traversal of the loop. The displacement value reflects the difference between an expected return position in the latent-space data structure and the actual observed position reported by loop detector 505. In some embodiments, holonomy calculator 510 may evaluate differences between embedding vectors corresponding to the start and end of the loop. In other embodiments, computational approximations inspired by path-ordered integration may be employed to capture the influence of the trajectory on representational orientation. Regardless of the selected method, holonomy calculator 510 outputs a finite-dimensional displacement value that summarizes the effect of the loop and transmits this value to holonomy integrator 520.

Holonomy register 515 provides a dedicated data structure for storing accumulated holonomy values across cognitive cycles. The register maintains a compact representation, such as a fixed-length vector or matrix, that encodes loop-derived invariants and persists across system activity and inactive intervals. Holonomy register 515 may also incorporate policies that modulate how prior contributions are retained, including decay mechanisms that attenuate older influence, reinforcement mechanisms that strengthen frequently observed patterns, or aggregation strategies that combine contributions from multiple loops. Stored holonomy values remain accessible to thought manager 230 for retrieval control and to executive core 105 for decision-making that benefits from long-range structural priors. Persistence layer 140 may serialize the contents of holonomy register 515 to ensure that these invariants are restored following system restart.

Holonomy integrator 520 receives the displacement value produced by holonomy calculator 510 and retrieves the current holonomy state from holonomy register 515. It applies an update rule configured to adjust the existing holonomy representation in response to the newly detected loop. Update operations may include summation of new displacement values with the current state, multiplicative transformations that update the orientation or magnitude of holonomy components, or decay and reinforcement strategies that manage the influence of past and present contributions. After computing the updated holonomy state, holonomy integrator 520 writes the result back to holonomy register 515. Updated holonomy values are then available to the broader system for retrieval biasing, structural interpretation, and memory organization.

In an embodiment, data flows through holonomy engine 120 as follows. As inference operations proceed within system 100, thought manager 230 and executive core 105 report trajectory information to loop detector 505. When loop detector 505 determines that an inference sequence has returned to a previously visited region of the latent-space data structure, it generates a loop specification and provides it to holonomy calculator 510. Holonomy calculator 510 computes a displacement value that represents the structural effect of the detected loop and transmits this value to holonomy integrator 520. Holonomy integrator 520 retrieves the current holonomy state from holonomy register 515, applies the configured update rule, and records the updated state in the register. Updated holonomy values are then made available to thought manager 230 for retrieval scoring and to executive core 105 for decisions that rely on long-range structural continuity. Persistence layer 140 may serialize the holonomy state for restoration after restart. The architecture supports holonomy accumulation through a fixed number of processor-executed operations that do not scale with loop length or latent-space size, enabling holonomy to function as an efficient structural signal that stabilizes inference and supports persistent cognition within system 100.

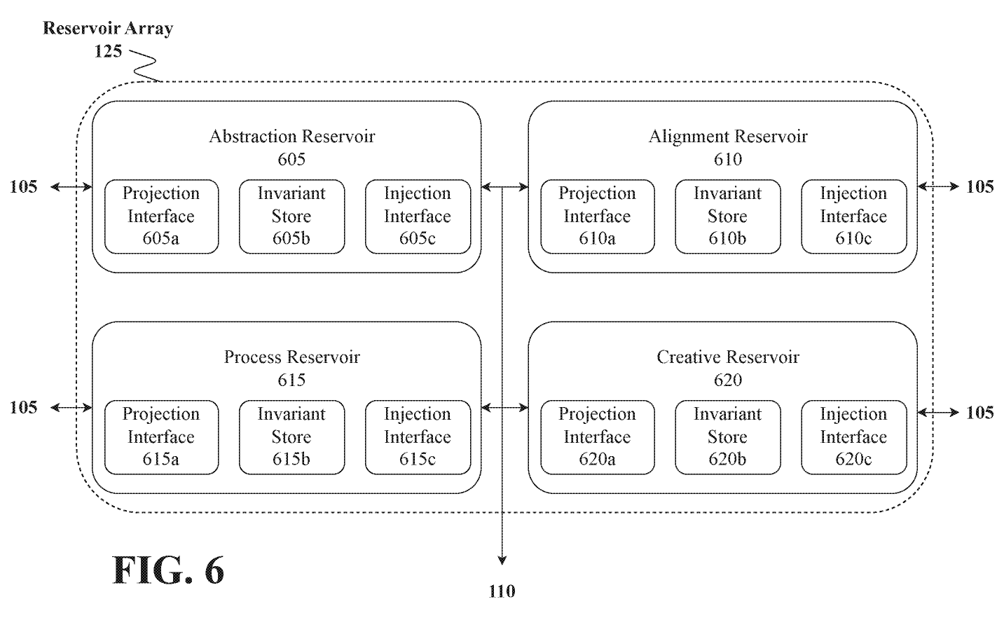

FIG. 6 is a block diagram illustrating an exemplary architecture of a reservoir array 125, in an embodiment. Within system 100, reservoir array 125 operates as a processor-executed collection of data structures configured to store and provide compressed invariant representations derived from curvature metrics. Reservoir array 125 functions as a structural buffer for the latent-space data structure, receiving curvature-derived data from curvature-exchange controller 220, transforming that data into compact invariant representations, and providing those invariants for reintegration into thought cache 110 when representational conditions warrant structural augmentation. By absorbing curvature from active manifold regions and supplying compressed structure during inference or maintenance cycles, reservoir array 125 supports coherence, consolidation, and controlled reorganization of stored cognitive content.

As illustrated, reservoir array 125 comprises four reservoirs, each oriented toward a distinct category of curvature-derived information. An abstraction reservoir 605 receives curvature associated with conflicting or tightly constrained representational conditions and generates compressed abstraction-oriented representations suitable for simplifying or restructuring complex regions of the manifold. An alignment reservoir 610 receives curvature reflecting unstable or irrelevant associations and produces stabilizing representations that support coherence across cognitive sectors. A process reservoir 615 receives curvature associated with repeated or overused representational patterns and produces representations that capture procedural regularities or frequently occurring inference patterns. A creative reservoir 620 receives curvature associated with sparse, surprising, or exploratory representational conditions and produces representations that may support non-local restructuring or the introduction of new relational motifs. Although each reservoir specializes in a particular curvature category, the underlying computational architecture is shared across all reservoirs.

In an embodiment, abstraction reservoir 605 receives curvature-derived data classified as conflict curvature by curvature-exchange controller 220. Such curvature may arise when representational elements form highly constrained or contradictory configurations within the latent-space data structure. Abstraction reservoir 605 compresses the incoming data into compact invariant representations that summarize structural conflicts in a form that may simplify subsequent reasoning. The reservoir may incorporate generated invariants into a stored collection of abstraction templates that influence how new thoughts are integrated into the latent space. The reservoir comprises a projection interface 605a that converts curvature-derived data into a compressed representation, an invariant store 605b that maintains the resulting representations in a persistent structure, and an injection interface 605c that provides stored invariants for reintegration into thought cache 110 upon request.

Alignment reservoir 610 receives curvature-derived data classified as noise curvature. Noise curvature may reflect unstable relationships or diffuse representational patterns that can reduce the system’s ability to maintain coherent sectors or produce stable retrieval sequences. Alignment reservoir 610 transforms this curvature into compact stabilizing representations that may assist in regulating the manifold’s geometry or mitigating drift across sectors. The reservoir comprises a projection interface 610a that compresses the curvature-derived signals, an invariant store 610b that retains stabilizing representations, and an injection interface 610c that returns such representations to thought cache 110 when alignment is desirable.

Process reservoir 615 receives curvature-derived data classified as redundancy curvature. Redundancy curvature may arise when repeated inference patterns or excessive similarity structures accumulate within localized regions of the latent-space data structure. Process reservoir 615 transforms the curvature into representations that summarize recurring structural patterns, producing invariants that may help streamline inference pathways or clarify procedural tendencies in the system’s cognitive behavior. The reservoir comprises a projection interface 615a that processes incoming redundancy curvature, an invariant store 615b that retains procedural representations, and an injection interface 615c that provides such representations for reintegration into memory during relevant cognitive operations.

Creative reservoir 620 receives curvature-derived data classified as novelty curvature. Novelty curvature may arise in regions marked by sparse representational organization, unexpected relationships, or conditions that indicate exploratory potential. Creative reservoir 620 compresses this curvature into invariant representations that capture non-local or cross-domain structural possibilities. Such representations may enrich the manifold by introducing alternative relational pathways or facilitating generative reinterpretation of stored content. The reservoir comprises a projection interface 620a that transforms novelty curvature into compressed forms, an invariant store 620b that retains generative representations, and an injection interface 620c that reintegrates such representations during cognitive processing or maintenance cycles.

Each reservoir within reservoir array 125 includes a projection interface, an invariant store, and an injection interface. The projection interface receives curvature-derived data delivered by curvature-exchange controller 220 and transforms that data into a compact invariant format suited to the corresponding reservoir type. Compression may be performed through computational techniques such as vector projection, matrix transformations, hash-based dimensionality reduction, or sparse tensor encoding. The invariant store maintains the resulting representations in a compact data structure that supports constant-size update operations. The injection interface retrieves stored invariants and transmits them to thought cache 110 when executive core 105 determines that representational conditions would benefit from structural augmentation or reorganization.

In an embodiment, data flows through reservoir array 125 as follows. Curvature-exchange controller 220 receives curvature classifications from curvature detection engine 115 and routes the curvature-derived data to the corresponding reservoir. Each reservoir’s projection interface transforms the received curvature-derived data into a compact invariant representation and updates the reservoir’s invariant store without requiring reorganization of stored content. When injection criteria are satisfied during active or maintenance-driven cognitive operation, curvature-exchange controller 220 signals one or more injection interfaces to retrieve stored invariants and deliver them to thought cache 110. Reintegration of these invariants into the latent-space data structure may influence similarity relationships, reduce representational tension, introduce abstraction or procedural templates, or encourage the formation of new relational structures in sparse regions of the manifold. Updated reservoir states are made available to persistence layer 140 for serialization so that accumulated invariants can be restored following a system restart. The architecture enables reservoir operations to proceed with constant-size computational cost, supporting efficient curvature regulation and structural evolution within system 100.

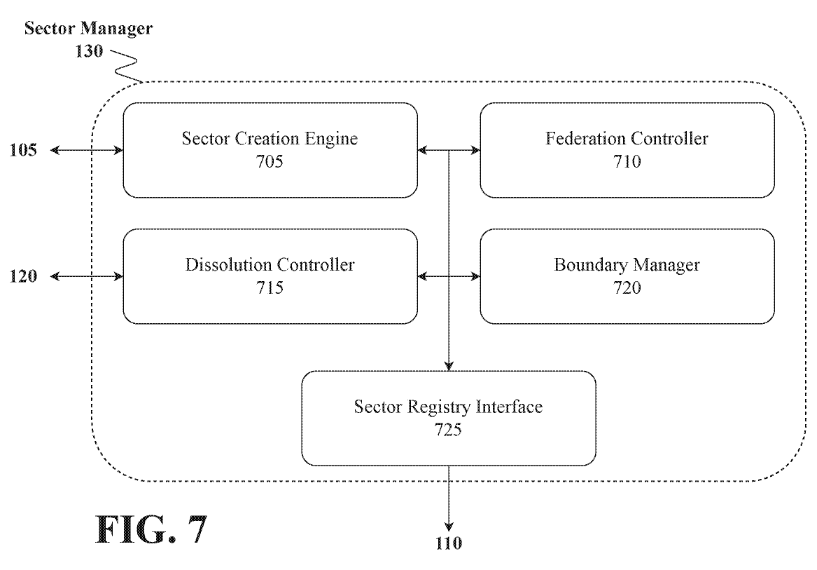

FIG. 7 is a block diagram illustrating an exemplary architecture of a sector manager 130, in an embodiment. Within system 100, sector manager 130 governs the dynamic topological organization of cognitive sectors within the latent-space data structure. Cognitive sectors function as logical groupings of thought representations that share structural similarity, curvature characteristics, activity patterns, or other representational correlations. Sector manager 130 regulates the creation of new sectors as representational conditions evolve, identifies circumstances under which existing sectors should be combined into federated structures, and determines when dormant or curvature-neutral sectors should be removed from the system. Through these operations, sector manager 130 enables system 100 to reorganize memory topology in a manner that adapts to structural changes without requiring movement or recomputation of the underlying embeddings. As illustrated, sector manager 130 comprises a sector creation engine 705, a federation controller 710, a dissolution controller 715, a boundary manager 720, and a sector registry interface 725. These components operate cooperatively to evaluate curvature patterns, interpret correlation and holonomy information, adjust sector boundaries, implement topology changes, and update the sector registry within thought cache 110.

In an embodiment, sector creation engine 705 evaluates curvature reports transmitted by curvature-exchange controller 220 to determine when new sector allocation is appropriate. Sector creation engine 705 identifies regions within the latent-space data structure where curvature accumulation exceeds a configured threshold and where no existing sector provides an adequate representational grouping. When these conditions are satisfied, sector creation engine 705 generates a specification for a new cognitive sector and identifies an initial set of representational boundaries associated with that sector. This specification is transmitted to boundary manager 720, which configures boundary definitions that describe the sector’s extent within the manifold. Creation activity may arise in response to persistent curvature spikes, emerging representational patterns that diverge from prior organization, or newly encountered thought clusters that exhibit structurally distinct behavior.

Federation controller 710 evaluates relationships among existing sectors to determine when sectors should be combined. Federation controller 710 receives correlation metrics derived from similarity evaluations across sector boundaries as well as holonomy similarity information reported by holonomy engine 120. When two or more sectors exhibit sustained correlation or share similar holonomy profiles, federation controller 710 identifies an opportunity to unify these sectors into a federated structure. The controller then produces a federation directive that is transmitted to boundary manager 720 for reconciliation of sector boundaries and to sector registry interface 725 for updates to the topology record. Federation supports consolidation of related representational spaces and improves coherence within the manifold by reducing redundant or overlapping groupings.

Dissolution controller 715 monitors activity levels and curvature absorption patterns for each sector to determine when a sector should be deallocated. Sector dissolution may occur when previously high-curvature regions become curvature-neutral following curvature pumping into reservoir structures or when representational activity within a sector declines sufficiently to indicate that the grouping no longer provides structural benefit. Dissolution controller 715 receives curvature absorption reports from curvature-exchange controller 220 and evaluates activity metrics retrieved from thought cache 110. When a sector satisfies dissolution criteria, dissolution controller 715 produces a dissolution directive that instructs boundary manager 720 to remove boundary definitions associated with the sector and instructs sector registry interface 725 to remove the corresponding entry from sector registry 330.

Boundary manager 720 maintains and updates sector boundaries in accordance with directives issued by sector creation engine 705, federation controller 710, and dissolution controller 715. Boundary manager 720 configures initial boundaries for newly created sectors, reconciles and merges boundaries for federated sectors, and removes boundaries associated with dissolved sectors. Boundary manager 720 may also adjust boundary definitions dynamically in response to changes in thought membership patterns, curvature flow directions, or local representational density. When boundary adjustments affect thought assignments, boundary manager 720 coordinates inter-sector reassignment of thought identifiers to ensure sector membership remains consistent with updated boundary structure.

Sector registry interface 725 coordinates propagation of topology changes to sector registry 330 within thought cache 110. This interface translates creation, federation, and dissolution directives into registry operations that update sector metadata, including sector identifiers, boundary definitions, relationship structures, and federation links. Sector registry interface 725 also transmits membership update notifications to the thought cache so that updated topology is reflected in sector-aware retrieval and memory operations. Through continuous synchronization between sector manager 130 and sector registry 330, system 100 maintains a coherent and dynamically adaptive representation of cognitive organization.

In an embodiment, data flows through sector manager 130 as follows. Curvature-exchange controller 220 transmits curvature reports to sector creation engine 705 and dissolution controller 715, providing information about curvature accumulation and curvature absorption across different regions of the latent space. Holonomy engine 120 transmits holonomy similarity information to federation controller 710. Correlation metrics derived from similarity computations across sector boundaries are also transmitted to federation controller 710. Sector creation engine 705 evaluates curvature conditions and produces sector specifications when appropriate. Federation controller 710 evaluates correlation and holonomy similarity and produces federation directives when sector consolidation is warranted. Dissolution controller 715 evaluates activity levels and curvature absorption conditions and produces dissolution directives when sectors no longer contribute meaningfully to the representational structure. Boundary manager 720 applies creation, federation, and dissolution directives by modifying boundary definitions and transmits resulting topology changes to sector registry interface 725. Sector registry interface 725 updates sector registry 330 and issues membership notifications to thought cache 110. These operations incur minimal computational cost because they operate on metadata and structural descriptors rather than on the embeddings themselves. The architecture therefore enables system 100 to adapt its representational topology continually while preserving computational efficiency.

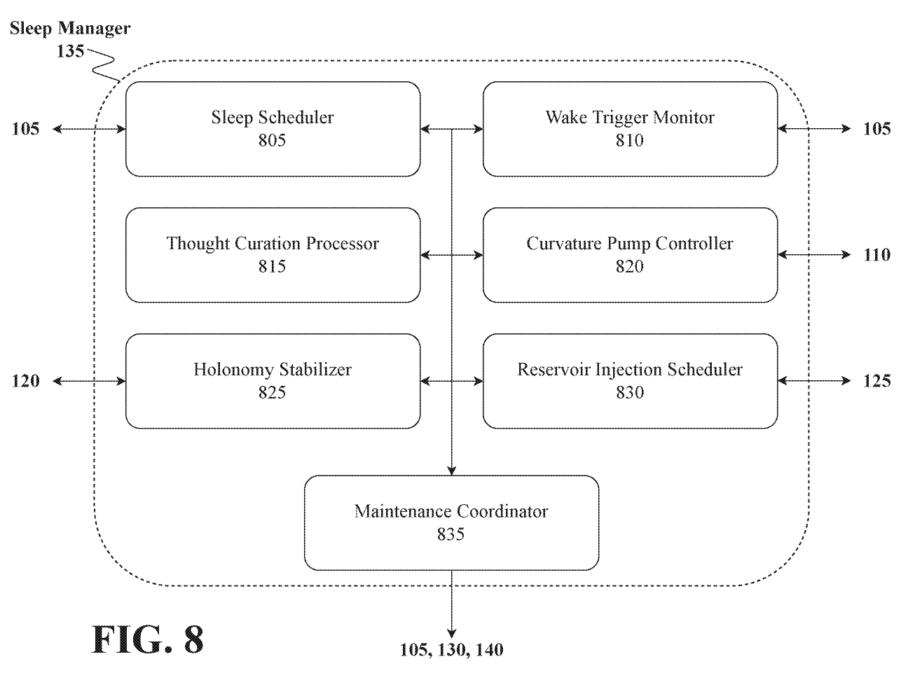

FIG. 8 is a block diagram illustrating an exemplary architecture of a sleep manager with curvature-regulated maintenance 135, in an embodiment. Within system 100, sleep manager 135 governs processor-executed sleep states during which the system reduces responsiveness to external input and devotes computational resources to internal maintenance operations. Sleep manager 135 extends traditional housekeeping routines with curvature-regulated processes that include curvature pumping to reservoir array 125, stabilization of holonomy values, injection of reservoir-stored invariants into thought cache 110, and adjustments to sector topology. These maintenance activities reorganize representational structures, consolidate accumulated information, and restore balanced manifold conditions that support efficient operation during active cognition. As illustrated, sleep manager 135 comprises a sleep scheduler 805, a wake trigger monitor 810, a thought curation processor 815, a curvature pump controller 820, a holonomy stabilizer 825, a reservoir injection scheduler 830, and a maintenance coordinator 835. These components operate together to determine sleep entry, monitor wake conditions, execute maintenance routines, and manage state transitions in cooperation with executive core 105.

Sleep scheduler 805 evaluates operational metrics provided by executive core 105 to determine when a sleep state should begin. It considers factors such as recent activity levels, accumulated curvature load across manifold regions, system resource utilization, and elapsed time since the previous maintenance cycle. When configured conditions are satisfied, sleep scheduler 805 signals executive core 105 to initiate a sleep state and notifies wake trigger monitor 810 that maintenance has begun. Sleep scheduler 805 may operate with multiple sleep modes that differ in duration or depth depending on the amount of curvature accumulation or the amount of maintenance required.

Wake trigger monitor 810 evaluates conditions that arise while the system is in sleep state. It receives external stimuli such as user input or other high-priority signals and compares them to configured wake criteria to determine whether maintenance should be interrupted. Wake trigger monitor 810 also receives status information from sleep scheduler 805 so that it remains informed of the current phase of the maintenance cycle. When a wake condition is detected, wake trigger monitor 810 signals executive core 105 to return the system to active cognition. Maintenance coordinator 835 may complete or suspend ongoing maintenance tasks to preserve consistency before the wake transition proceeds.

Thought curation processor 815 carries out traditional maintenance operations associated with memory organization. These operations include consolidation of recently stored thoughts from short-term cache 305 into long-term cache 310, generalization of specific experiences into broader representational structures, generation of new representational combinations from existing content, and pruning of low-relevance or redundant information. Thought curation processor 815 receives activation signals from sleep scheduler 805 and communicates with thought cache 110 to carry out these restructuring operations. Completion information is returned to maintenance coordinator 835 to support proper sequencing with additional maintenance processes.

Curvature pump controller 820 performs curvature-regulated maintenance operations by directing curvature-derived data from high-curvature manifold regions into reservoir array 125. It receives activation signals from sleep scheduler 805 and evaluates curvature patterns stored within thought cache 110 to identify areas in which curvature accumulation has exceeded desirable levels. Curvature pump controller 820 routes the corresponding curvature-derived data to reservoir array 125 for compression and storage in accordance with the curvature classification assigned by curvature-detection engine 115. Pump completion status is provided to maintenance coordinator 835.

Holonomy stabilizer 825 performs stabilization operations on holonomy values stored in holonomy register 515 of holonomy engine 120. These stabilization operations may include applying configurable decay factors, combining multiple loop-derived contributions into consolidated forms, and reinforcing structural priors that have been repeatedly observed. Holonomy stabilizer 825 receives sleep activation signals from sleep scheduler 805 and issues stabilization instructions to holonomy engine 120. Stabilization results are reported to maintenance coordinator 835, enabling a coordinated maintenance cycle.

Reservoir injection scheduler 830 evaluates reservoir states and representational conditions within thought cache 110 to identify opportunities for structural enrichment through injection of stored invariants. When such conditions are present, reservoir injection scheduler 830 issues instructions to reservoir array 125 to deliver selected invariants back into the thought cache. Injection operations may occur after curvature pumping to rebalance manifold structure or to introduce abstraction templates, stabilizing priors, or other invariant representations that support smoother cognitive activity. Completion status is reported to maintenance coordinator 835 to ensure correct ordering with other maintenance tasks.

Maintenance coordinator 835 supervises the sequence of maintenance activities executed during sleep. It receives progress reports from thought curation processor 815, curvature pump controller 820, holonomy stabilizer 825, and reservoir injection scheduler 830, and determines appropriate ordering and dependencies among their operations. Maintenance coordinator 835 may request topology optimization from sector manager 130 after curvature pumping and reservoir injection have altered representational geometry. When maintenance activities are complete, maintenance coordinator 835 signals persistence layer 140 to generate an updated state snapshot and notifies sleep scheduler 805 that maintenance is finished.

In an embodiment, data flows through sleep manager 135 as follows. Executive core 105 provides activity data, curvature load metrics, and system resource indicators to sleep scheduler 805, which evaluates these metrics against configured sleep thresholds. When sleep entry is warranted, sleep scheduler 805 initiates the transition into sleep state and activates the maintenance components. Thought curation processor 815 restructures stored information in thought cache 110. Curvature pump controller 820 transfers curvature-derived data into reservoir array 125. Holonomy stabilizer 825 consolidates loop-derived invariants in holonomy engine 120. Reservoir injection scheduler 830 performs injections that enrich representational structure within the latent space. Maintenance coordinator 835 sequences these tasks and invokes sector manager 130 for topology adjustments as needed. Maintenance coordinator 835 also instructs persistence layer 140 to capture a state snapshot reflecting updated representational conditions. Throughout this interval, wake trigger monitor 810 evaluates incoming stimuli to decide whether maintenance should end earlier than scheduled. When maintenance is complete or a wake trigger is detected, sleep scheduler 805 coordinates return to active cognition through executive core 105 with updated cognitive structures in place.

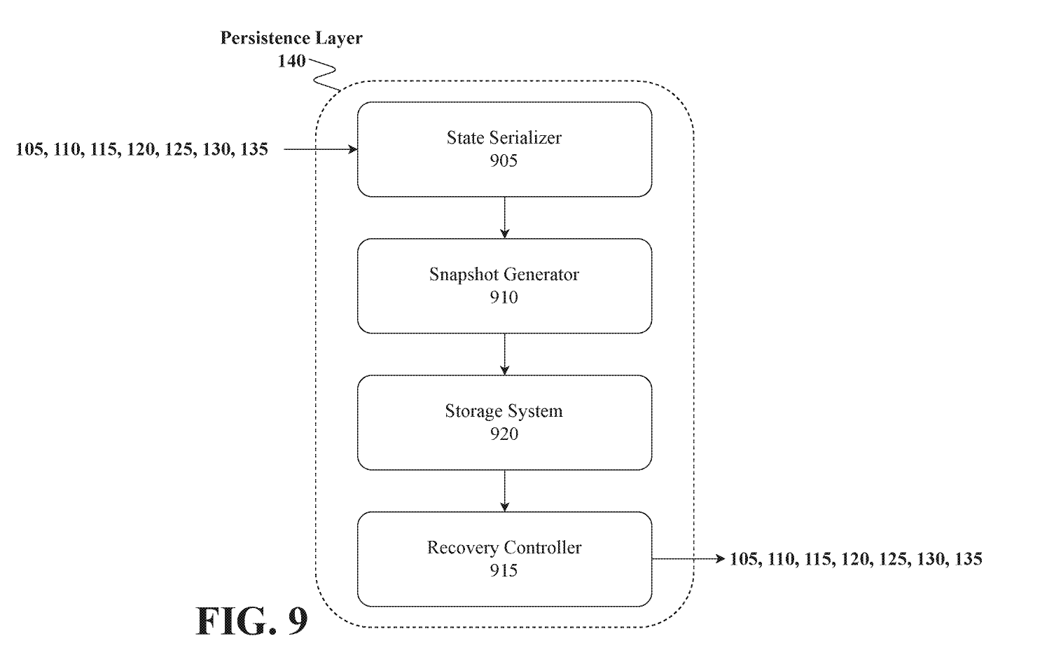

FIG. 9 is a block diagram illustrating an exemplary architecture of a persistence layer 140, in an embodiment. Within system 100, persistence layer 140 provides mechanisms by which the system preserves and restores cognitive state across shutdowns and restarts. Persistence layer 140 receives runtime state from thought cache 110, holonomy engine 120, reservoir array 125, sector registry 330, and curvature map layer 325, transforms this state into serialized forms suitable for durable storage, and writes these serialized representations to non-volatile media. Upon system initialization, persistence layer 140 retrieves previously stored state, reconstructs the corresponding runtime data structures, and restores the system to its prior representational condition so that thought content, curvature information, holonomy values, reservoir invariants, and sector organization are reinstated. As illustrated, persistence layer 140 comprises a state serializer 905, a snapshot generator 910, a recovery controller 915, and a storage system 920. These components operate in coordination to capture runtime state, assemble consistent snapshots, manage durable storage, and restore cognitive structures following restart.

State serializer 905 receives data from the various memory and structural components of system 100 and converts that data into serialized formats appropriate for persistent storage. It receives thought representations, embedding vectors, and semantic structures from thought cache 110, holonomy register contents from holonomy engine 120, invariant-store content from reservoir array 125, sector topology metadata from sector registry 330, and curvature-value structures from curvature map layer 325. State serializer 905 transforms these heterogeneous data structures into a unified serialized representation using an appropriate format such as binary encoding or structured serialization protocols. Serialized output is forwarded to snapshot generator 910 for inclusion in point-in-time snapshots.

Snapshot generator 910 constructs consistent snapshots of the system’s representational state at configurable intervals. It receives serialized data from state serializer 905 and assembles a snapshot that captures the state of all relevant components at a single logical instant. Snapshot generator 910 may construct complete snapshots containing the entire cognitive state or incremental snapshots containing changes since a previously stored snapshot. Snapshot generator 910 coordinates serialization timing to prevent conflicting or inconsistent state capture and transmits completed snapshots to storage system 920 for durable retention.

Recovery controller 915 restores stored cognitive state when the system resumes operation after shutdown. Upon initialization, recovery controller 915 requests stored snapshots from storage system 920 and selects the most recent valid snapshot. Recovery controller 915 deserializes the snapshot and reconstitutes the corresponding runtime structures. Thought cache 110 is repopulated with stored embeddings and semantic structures, holonomy engine 120 receives restored holonomy register content, reservoir array 125 is populated with invariant-store data, and sector registry 330 receives restored topology metadata. Validation routines ensure that reconstructed structures are coherent and complete before executive core 105 transitions the system to active operation.

Storage system 920 maintains durable storage for snapshots produced by snapshot generator 910. It stores both current snapshots and backup copies for redundancy using non-volatile media such as solid-state storage, magnetic storage, or network-accessible storage services. Storage system 920 may employ storage tiering to optimize snapshot access and long-term retention. During normal operation, storage system 920 receives snapshots from snapshot generator 910, and during restoration operations, it provides stored snapshots to recovery controller 915.

Persistence layer 140 supports serialization and restoration of the additional representational structures introduced by the present embodiments. These include curvature maps comprising sparse values associated with representational distortion across the latent-space data structure, holonomy registers comprising finite-dimensional representations derived from cyclic inference activity, reservoir states comprising compressed invariant structures held within reservoir array 125, and sector topology metadata describing relationships and boundaries among cognitive sectors. Persisting these structures ensures that the system not only restores stored thoughts but also restores the structural information and invariant representations that contribute to curvature-regulated cognitive behavior.

In an embodiment, data flows through persistence layer 140 as follows. During runtime, state serializer 905 collects data from thought cache 110, holonomy engine 120, reservoir array 125, sector registry 330, and curvature map layer 325 and converts this information into serialized formats. Snapshot generator 910 assembles the serialized content into a coherent snapshot and transfers the snapshot to storage system 920. After system restart, recovery controller 915 retrieves the most recent snapshot from storage system 920, deserializes its contents, and restores thought representations, invariant structures, curvature maps, holonomy registers, and sector topology metadata to their respective runtime components. Once the restoration completes, system 100 resumes active cognitive operation with the structural state preserved from the prior session. This persistence mechanism supports continuity of cognitive structure across inactive intervals and maintains accumulated representational information over extended operational periods.

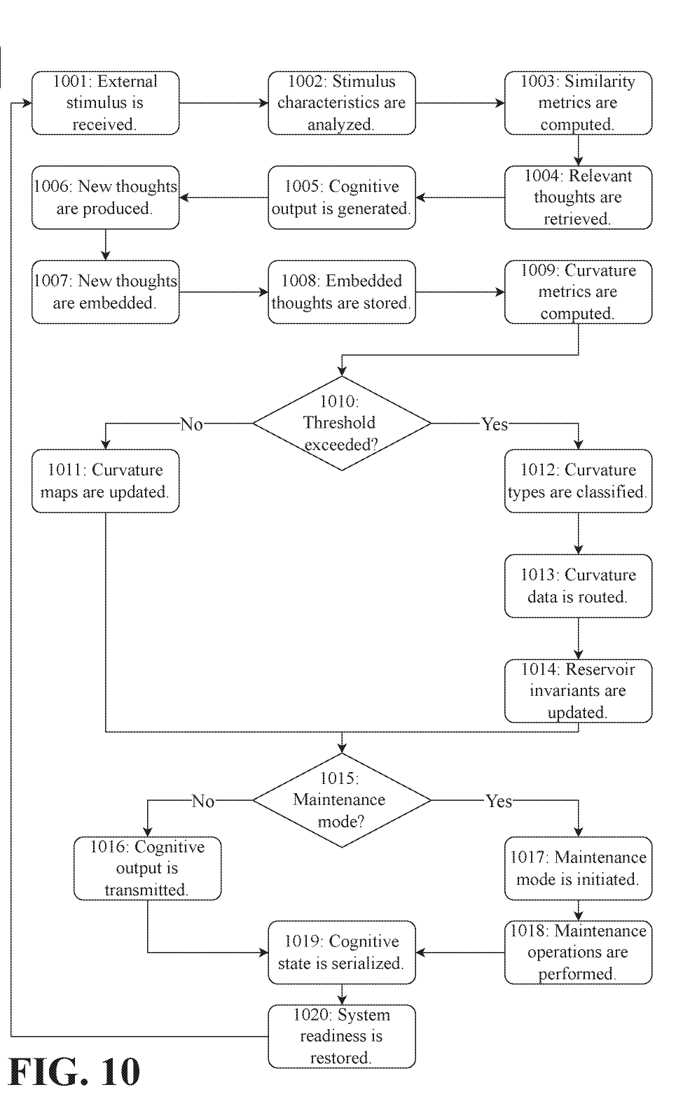

FIG. 10 is a flow diagram illustrating exemplary primary cognitive processing of a PCM with generalized curvature exchange dynamics 100, in an embodiment. The illustrated method depicts a non-limiting example of a cognitive processing cycle in which stimulus analysis, thought retrieval, output generation, curvature evaluation, conditional reservoir exchange, holonomy-based structural updating, and persistence operations are executed by one or more processors. This cycle may be repeated as system 100 receives stimuli and updates a persistent cognitive state.

In an embodiment, the method begins when external interface 101 receives an external stimulus such as, for example, user input, an API call, or a document submission, and transmits the stimulus to executive core 105, step 1001. Stimulus analyzer 210 processes the stimulus to generate an analysis report including intent indicators, content classification, priority scoring, and curvature-relevance features, step 1002.

Based on that analysis, decision coordinator 215 directs thought manager 230 to evaluate similarity within a latent-space data structure of thought cache 110 using one or more similarity metrics, sector cues, or holonomy-informed retrieval biases, step 1003. Thought manager 230 queries thought cache 110 to retrieve one or more relevant thought representations responsive to this request, step 1004.

In an embodiment, decision coordinator 215 transmits the retrieved thoughts and the external stimulus to language and reasoning models 145, which generate a cognitive output informed by retrieved context, step 1005. Language and reasoning models 145 further generate one or more new thoughts derived from analyzing the stimulus and retrieved context, step 1006. Embedded vector store 315 transforms the new thoughts into vector embeddings positioned within a latent-space data structure, step 1007. Thought manager 230 stores the embeddings in thought cache 110 and assigns sector membership based at least in part on semantic similarity, representational proximity, or curvature conditions, step 1008.

Curvature detection engine 115 computes a curvature metric associated with manifold regions influenced by the newly stored thoughts, step 1009. Threshold comparator 425 evaluates whether the curvature metric exceeds one or more configured thresholds, step 1010. If no threshold is exceeded, curvature values are recorded in curvature map layer 325, step 1011. If a threshold is exceeded, curvature-classification component 420 classifies the observed curvature as, for example, conflict curvature, noise curvature, redundancy curvature, or novelty curvature, step 1012.

Curvature-exchange controller 220 routes curvature-derived representations to a reservoir within reservoir array 125 according to the classification outcome, step 1013. In an embodiment, the receiving reservoir compresses the curvature-derived representation through a projection interface and updates an invariant store using a constant-size update operation, step 1014. Following storage, or if no threshold was exceeded, the method updates curvature map layer 325 and continues evaluation of additional structural or operational conditions.

In some embodiments, holonomy engine 120 receives inference-trajectory information generated during steps 1003–1008 and determines whether a cyclic inference sequence has occurred. When a loop closure is detected, holonomy engine 120 computes a loop-derived invariant and updates holonomy register 515 using an additive, multiplicative, or decayed update rule. Holonomy values are thereby available to bias subsequent retrieval operations or influence representational interpretation during the next cycle.

Executive core 105 evaluates whether conditions for cognitive maintenance mode have been satisfied based on, for example, activity levels, cumulative curvature load, holonomy variation, or elapsed time since a previous maintenance interval, step 1015. If maintenance mode is not triggered, system 100 transmits the generated cognitive output to external interface 101 for delivery to a requesting entity, step 1016. In some embodiments, decision coordinator 215 may also request reservoir injection during active cognition when contextual enrichment is desirable.

If maintenance mode is triggered, sleep manager 135 initiates entry into a processor-executed cognitive maintenance state with reduced external responsiveness, step 1017. During maintenance, sleep manager 135 coordinates one or more operations including curvature pumping that transfers curvature-derived data from thought cache 110 to reservoir array 125, reservoir injection that introduces invariant representations into the latent-space data structure, holonomy stabilization that consolidates loop-derived invariants, and topology adjustments directed to sector manager 130, step 1018.

Upon completion of maintenance operations, persistence layer 140 serializes updated cognitive state—including, for example, thought cache content, curvature maps, holonomy registers, reservoir states, and sector topology metadata—to non-volatile storage, step 1019. After persistence (or when maintenance mode was not invoked), system 100 transmits any pending cognitive output and awaits subsequent stimuli, step 1020. Upon receipt of additional input, the method may return to step 1001. Through iterative execution of these operations, system 100 accumulates curvature-derived invariants, maintains representational coherence through exchange flows, and preserves structural and cognitive continuity across processing cycles and restarts.

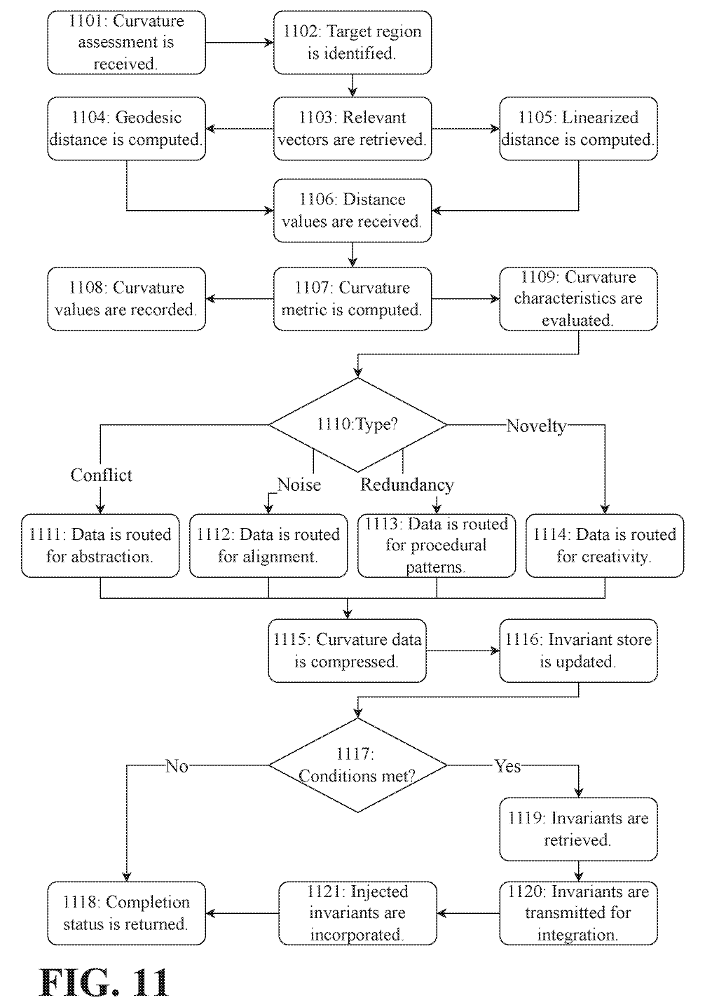

FIG. 11 is a flow diagram illustrating exemplary curvature computation and curvature exchange flow within a PCM with generalized curvature exchange dynamics 100, in an embodiment. The illustrated method depicts a non-limiting sequence of processor-executed operations beginning with curvature assessment and continuing through metric derivation, curvature classification, reservoir-directed compression, and conditional injection of invariant representations into a latent-space data structure. This curvature exchange flow enables system 100 to detect representational distortion, classify curvature according to contextual characteristics, compress curvature-derived information into reservoir structures, and selectively reinject compressed invariants to reshape manifold geometry and regulate constraint density.

In an embodiment, the method begins when curvature-exchange controller 220 receives a curvature assessment request that specifies a thought pair or manifold region for evaluation, step 1101. Curvature-exchange controller 220 identifies the relevant embeddings within a latent-space data structure maintained by thought cache 110, step 1102. Curvature detection engine 115 retrieves the corresponding thought vectors from embedded vector store 315, step 1103. Geodesic distance calculator 405 computes, for example, a geodesic approximation d(x, y) between the retrieved vectors using sparse geodesic probing techniques, step 1104. In parallel, linearized distance calculator 410 computes a linearized or expected distance d_lin(x, y) using a Euclidean metric or tangent-map approximation, step 1105.

Curvature derivation component 415 receives the geodesic and linearized distance values, step 1106, and computes a curvature metric K(x, y) representing the deviation between the two measures, step 1107. Derived curvature values are stored in curvature map layer 325 for future reference and trend analysis, step 1108. Curvature-classification component 420 evaluates one or more characteristics of the curvature metric—including magnitude, sign, local manifold density, or sector-level distortion patterns—and assigns a curvature category responsive to those characteristics, step 1109. Classification may identify, for example, conflict curvature, noise curvature, redundancy curvature, or novelty curvature, step 1110.

If the curvature is classified as conflict curvature associated with incompatible or highly constrained representational conditions, curvature-exchange controller 220 routes curvature-derived data to abstraction reservoir 605 within reservoir array 125, step 1111. If the curvature is classified as noise curvature associated with unstable or irrelevant associations, curvature-exchange controller 220 routes curvature-derived data to alignment reservoir 610, step 1112. If the curvature is classified as redundancy curvature associated with repeated or overconstrained structural patterns, curvature-exchange controller 220 routes curvature-derived data to process reservoir 615, step 1113. If the curvature is classified as novelty curvature associated with sparse or exploratory representational regions, curvature-exchange controller 220 routes curvature-derived data to creative reservoir 620, step 1114. For example, conflict curvature may be routed to abstraction reservoir 605, noise curvature to alignment reservoir 610, redundancy curvature to process reservoir 615, and novelty curvature to creative reservoir 620.

In an embodiment, the selected reservoir receives routed curvature-derived data at a projection interface and transforms the data into a low-dimensional invariant representation using one or more configured compression techniques such as, for example, vector projection or sparse tensor encoding, step 1115. The invariant representation is incorporated into an invariant store using a constant-size update operation that avoids reorganization of stored data, step 1116.

Curvature-exchange controller 220 evaluates injection criteria based on contextual conditions, representational needs, recent curvature trends, or maintenance-state status, step 1117. If injection criteria are not satisfied, a completion indicator is returned to curvature-exchange controller 220, step 1118. If injection criteria are satisfied, one or more reservoirs retrieve compressed invariants from corresponding invariant stores through an injection interface, step 1119. Retrieved invariants are transmitted to thought cache 110 for incorporation into a latent-space data structure, step 1120. Embedded vector store 315 integrates the injected invariants, which may alter similarity relationships, reduce constraint density in high-curvature regions, or introduce abstraction templates that reshape local manifold geometry, step 1121.

In some embodiments, holonomy engine 120 may also update loop-derived invariants when injected structures influence inference trajectories, thereby adjusting holonomy registers used to guide subsequent retrieval or structural interpretation. Sector manager 130 may optionally evaluate whether curvature redistribution or invariant injection warrants sector creation, federation, or dissolution.

Following injection or confirmation that no injection is required, curvature-exchange controller 220 marks the curvature exchange cycle as complete, and system 100 resumes ongoing cognitive processing or awaits subsequent curvature assessment requests. This curvature exchange flow enables continual regulation of representational complexity through efficient detection, compression, and selective reintegration of curvature-derived structural information.

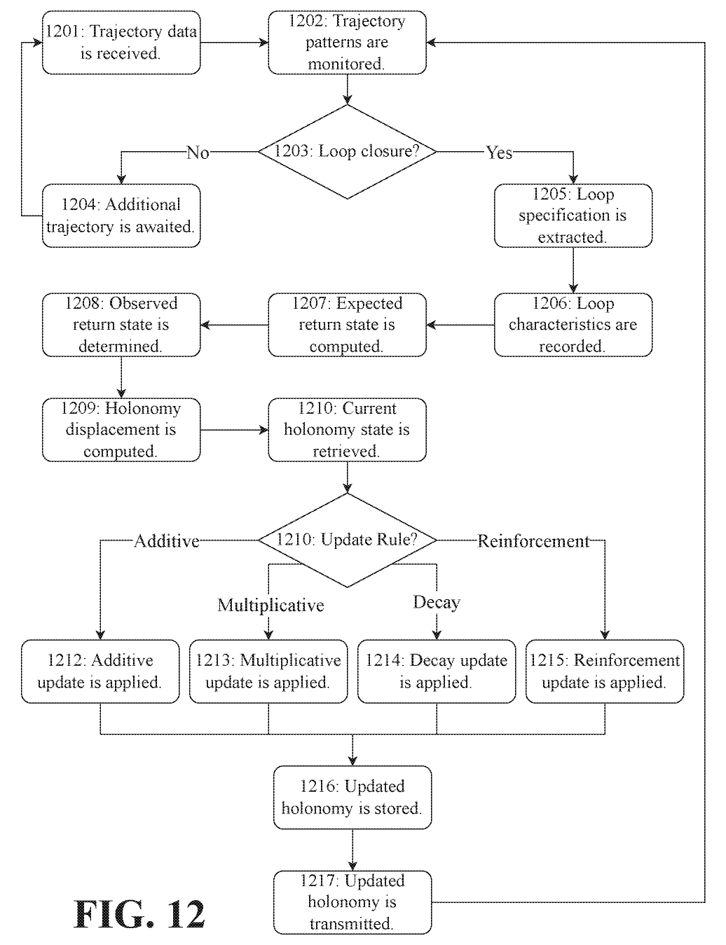

FIG. 12 is a flow diagram illustrating exemplary holonomy accumulation within a PCM with generalized curvature exchange dynamics 100, in an embodiment. The illustrated method depicts a non-limiting sequence of processor-executed operations by which holonomy engine 120 detects cyclic inference sequences, computes loop-derived displacement values, applies one or more configured update rules, and distributes accumulated holonomy to influence retrieval and decision-making processes within system 100. This holonomy accumulation flow enables generation and maintenance of compact structural invariants derived from repeated reasoning patterns.

In an embodiment, the method begins when holonomy engine 120 receives inference-trajectory data from thought manager 230 and executive core 105 as reasoning operations proceed, step 1201. Loop detector 505 monitors the received trajectory data for indicators of a cyclic inference path within a latent-space data structure, step 1202. Loop detector 505 evaluates whether a loop closure condition is satisfied by determining whether the current trajectory has returned to, or is within a configurable similarity threshold of, a previously visited representational region, step 1203. If no loop closure is detected, loop detector 505 continues monitoring incoming trajectory information, step 1204, and the method returns to step 1202.

If a loop closure is detected, loop detector 505 extracts a loop specification summarizing characteristics of the detected cycle, step 1205. The loop specification identifies, for example, a starting representation, an intermediate trajectory description, and an endpoint representation relative to the starting point, step 1206. Holonomy calculator 510 computes an expected return representation using, for example, a linearized or similarity-based prediction derived from the starting representation and the assumption of an idealized closed transition, step 1207. Holonomy calculator 510 also determines an observed return representation based on the actual embedding reached after traversing the inference loop, step 1208.

Holonomy calculator 510 computes a holonomy displacement ΔH as a deviation between the expected and observed return representations, step 1209. Holonomy integrator 520 retrieves the current stored holonomy state H(t) from holonomy register 515, step 1210, and selects a configured update rule responsive to system settings or contextual conditions, step 1211.

If an additive update rule is configured, holonomy integrator 520 computes H(t+1) by summing H(t) with ΔH, step 1212. If a multiplicative update rule is configured, holonomy integrator 520 computes H(t+1) by applying a multiplicative transformation derived from ΔH to H(t), step 1213. If a decay-based update rule is configured, holonomy integrator 520 applies a decay factor to attenuate prior contributions before integrating ΔH, step 1214. If a reinforcement-based update rule is configured, holonomy integrator 520 increases the weighting of components within H(t) that correspond to representational features present in ΔH, step 1215.

Upon application of the selected update rule, holonomy integrator 520 stores the updated holonomy state H(t+1) in holonomy register 515, step 1216. Holonomy engine 120 transmits the updated holonomy representation to thought manager 230 to support retrieval biasing and to executive core 105 to influence curvature interpretation or decision-coordination logic, step 1217. The method returns to step 1202, where loop detector 505 continues monitoring inference-trajectory data for additional cyclic patterns. This holonomy accumulation flow enables system 100 to maintain compact, constant-size structural invariants that enrich persistent cognition without scaling with loop length or latent-space size.

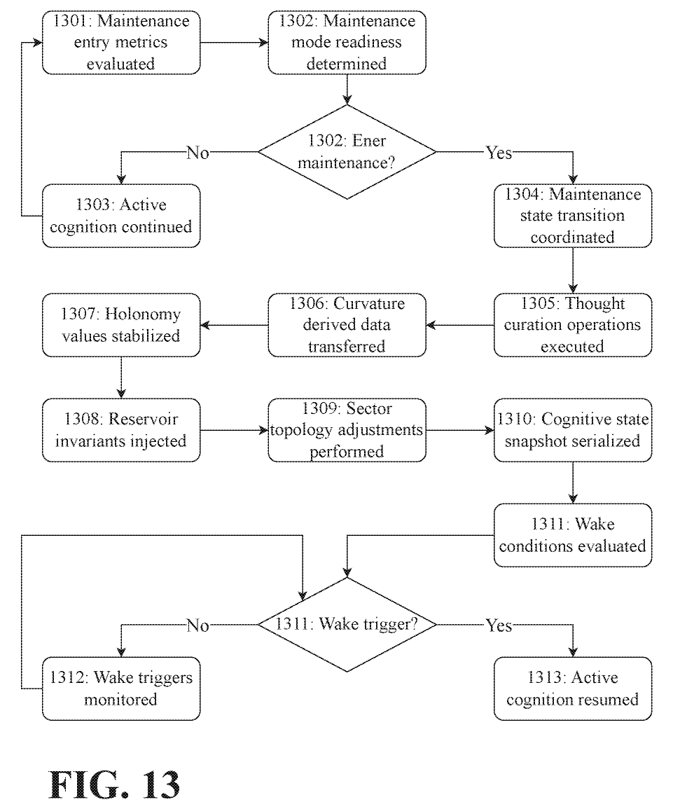

FIG. 13 is a block diagram illustrating exemplary curvature regulated cognitive maintenance of a PCM system with generalized curvature exchange dynamics 100, in an embodiment. The illustrated method depicts a non limiting sequence of processor executed operations by which sleep manager 135 coordinates internal reorganization of cognitive structures during a period of reduced external responsiveness. This maintenance flow integrates curvature pumping, holonomy stabilization, reservoir injection, and sector topology optimization into a unified maintenance cycle that preserves and enriches the persistent cognitive state.

In an embodiment, the method begins when sleep manager 135 evaluates operational metrics to detect whether maintenance entry conditions are satisfied, step 1301. A sleep scheduler 805 receives activity data, cumulative curvature load indicators, resource utilization metrics, and elapsed time since a prior maintenance cycle from executive core 105. Based on these metrics, sleep manager 135 determines whether the system should enter a cognitive maintenance mode, step 1302. If entry conditions are not satisfied, sleep manager 135 signals executive core 105 to continue active cognition and the method returns to monitoring for subsequent maintenance opportunities, step 1303.

If maintenance entry conditions are satisfied, sleep manager 135 coordinates with executive core 105 to transition the system to a cognitive maintenance state with reduced responsiveness to external stimuli, step 1304. A maintenance coordinator 835 sequences subsequent maintenance operations by issuing control signals that define processing order among participating subsystems and coordinates data flow required for those operations. A thought curation processor 815 executes thought curation operations on thought cache 110, which may include consolidation of recently stored thoughts from short term cache 305 to long term cache 310, generalization of specific experiences into broader representational structures, and pruning of low relevance content, step 1305.

Following thought curation, a curvature pump controller 820 coordinates transfer of curvature derived data from high curvature regions of a latent space data structure to reservoir array 125, step 1306. Curvature pump controller 820 evaluates curvature patterns stored in curvature map layer 325 to identify manifold regions where curvature accumulation exceeds desirable levels and applies routing logic that maps curvature derived data to reservoir types based on curvature classification. A holonomy stabilizer 825 then applies update rules to adjust holonomy values stored in holonomy register 515, which may include applying decay factors, consolidating multi loop contributions, or reinforcing structural priors observed through repeated inference cycles, step 1307.

A reservoir injection scheduler 830 evaluates reservoir states and representational conditions within thought cache 110 and triggers injection of compressed invariants from reservoir array 125 into a latent space data structure, step 1308. Injected invariants may reshape similarity relationships, reduce representational tension in previously high curvature regions, or introduce abstraction templates that support subsequent cognitive processing. Sector manager 130 evaluates whether curvature redistribution or invariant injection warrants adjustment of sector topology and executes sector creation, federation, or dissolution operations as appropriate, step 1309. A sector registry interface 725 propagates topology changes to sector registry 330 within thought cache 110.

Upon completion of maintenance operations, persistence layer 140 serializes updated cognitive state to non volatile storage, step 1310. A snapshot generator 910 assembles serialized data from thought cache 110, holonomy engine 120, reservoir array 125, and sector registry 330 into a consistent snapshot suitable for restoration upon system restart. Sleep manager 135 evaluates whether a wake trigger has been detected or whether maintenance operations are complete, step 1311. Wake triggers may include external stimuli such as user input or high priority signals that satisfy configured wake criteria.

If no wake trigger is detected and maintenance is not yet complete, a wake trigger monitor 810 continues to monitor for conditions that would warrant early exit from the maintenance state, step 1312. Wake trigger monitor 810 receives external stimuli and compares them against configured wake criteria while maintenance coordinator 835 manages any remaining maintenance tasks. When a wake trigger is detected or maintenance operations are complete, sleep manager 135 coordinates with executive core 105 to transition the system to an active cognitive state with updated cognitive structures in place, step 1313. The method may return to step 1301 upon subsequent satisfaction of maintenance entry conditions during continued system operation.

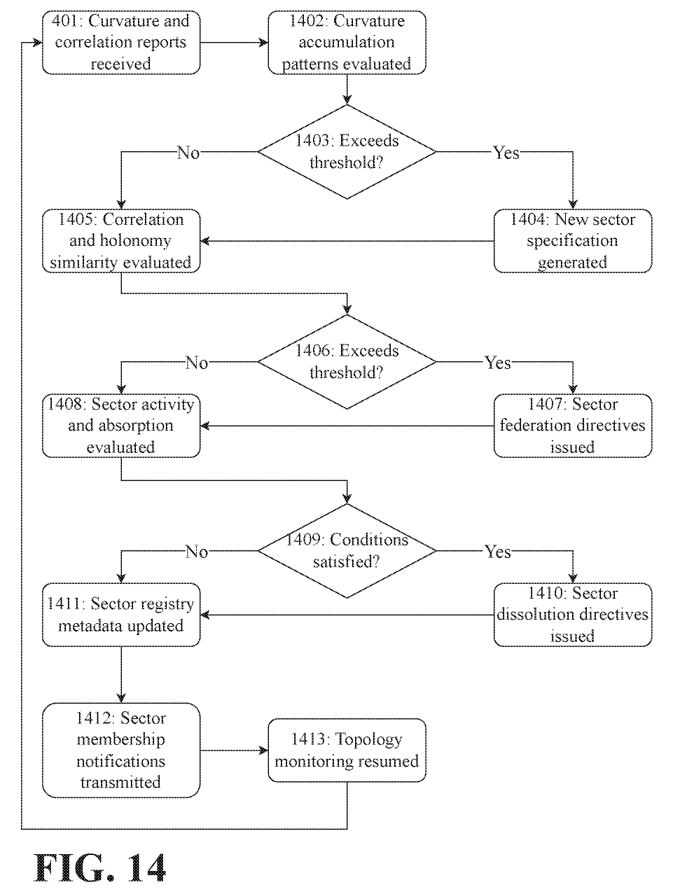

FIG. 14 is a flow diagram illustrating exemplary dynamic sector topology management within a PCM system with generalized curvature exchange dynamics 100, in an embodiment. The illustrated method depicts a non limiting sequence of processor executed operations by which sector manager 130 evaluates representational conditions and adjusts the organization of cognitive sectors within a latent space data structure. This topology management flow enables the system to create new sectors in response to curvature accumulation, federate related sectors in response to detected correlation, and dissolve sectors when curvature has been absorbed by reservoir structures.

In an embodiment, the method begins when sector manager 130 receives curvature reports from curvature exchange controller 220 and correlation reports derived from similarity evaluations across sector boundaries, step 1401. Sector manager 130 may also receive holonomy similarity information from holonomy engine 120. A sector creation engine 705 evaluates curvature accumulation patterns within manifold regions to identify areas where representational distortion has increased, step 1402. Sector creation engine 705 evaluates whether curvature in any region exceeds a configured creation threshold, step 1403.

If curvature exceeds a creation threshold in a region that lacks adequate sector assignment, sector creation engine 705 generates a specification for a new cognitive sector and identifies initial boundary definitions associated with that sector, step 1404. A boundary manager 720 configures boundary definitions that describe the new sector’s extent within a latent space data structure. Creation activity may arise in response to persistent curvature spikes, emerging representational patterns that diverge from prior organization, or newly encountered thought clusters exhibiting structurally distinct behavior.

Following evaluation of creation conditions, a federation controller 710 evaluates correlation metrics and holonomy similarity across existing sectors, step 1405. Federation controller 710 evaluates whether correlation or holonomy similarity between two or more sectors exceeds a configured federation threshold, step 1406. If correlation exceeds a federation threshold, federation controller 710 issues a federation directive that combines the correlated sectors into a federated structure with reconciled boundaries and shared curvature handling, step 1407. Boundary manager 720 reconciles boundary definitions for federated sectors and updates relationship metadata accordingly.

Following evaluation of federation conditions, a dissolution controller 715 evaluates sector activity levels and curvature absorption patterns, step 1408. Dissolution controller 715 receives curvature absorption reports from curvature exchange controller 220 indicating regions where curvature has been transferred to reservoir array 125. Dissolution controller 715 evaluates whether dissolution conditions are satisfied for any sector based on reduced activity and successful curvature absorption, step 1409. If dissolution conditions are satisfied, dissolution controller 715 issues a dissolution directive that removes the inactive sector from the topology, step 1410. Boundary manager 720 removes boundary definitions associated with the dissolved sector.

Upon completion of topology evaluation and any resulting creation, federation, or dissolution operations, a sector registry interface 725 updates sector registry 330 to reflect current topology, step 1411. Sector registry interface 725 translates topology directives into registry operations that modify sector metadata including sector identifiers, boundary definitions, relationship structures, and federation links. Sector registry interface 725 transmits membership update notifications to thought cache 110 so that updated topology is reflected in sector aware retrieval and memory operations, step 1412. Thought cache 110 adjusts sector membership for affected thought representations by updating membership metadata without requiring large scale data migration.

Following registry updates and notification, sector manager 130 returns to monitoring curvature and correlation conditions for subsequent topology evaluation cycles, step 1413. The method may return to step 1401 upon receipt of additional curvature reports or correlation metrics from ongoing cognitive processing or maintenance operations. Through iterative execution of these operations, system 100 adapts its representational topology to changing structural conditions while preserving computational efficiency.

### Exemplary Computing Environment

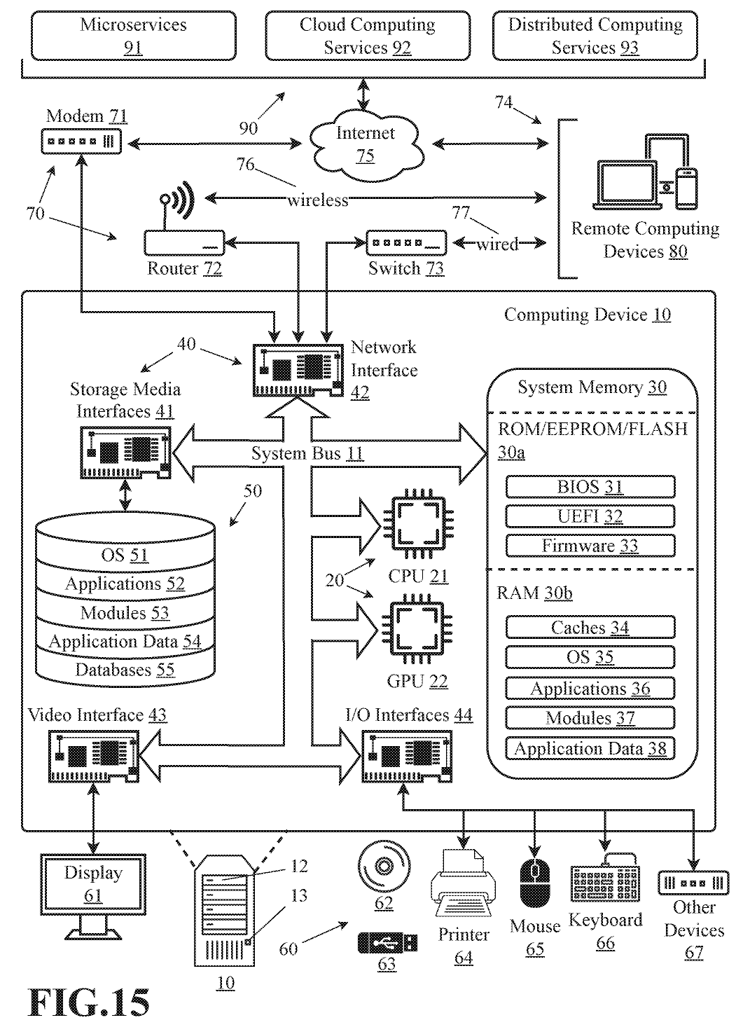

FIG. 15 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non- volatile data storage device 50. Network interface 42 provides the necessary hardware interface for computing device 10to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10 . Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40 , NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computer system configured to execute software instructions stored on nontransitory machine-readable storage media, wherein the software instructions comprise instructions that:
initialize a persistent cognitive system configured to sustain a cognitive state across inactive periods and restarts, the cognitive state comprising stored thought representations organized in one or more thought caches as vector embeddings within a latent-space data structure;
monitor a plurality of events comprising external stimuli to the persistent cognitive system and thought triggers internal to the persistent cognitive system;
retrieve relevant thoughts from the thought cache based on similarity metrics computed within the latent-space data structure;
generate cognitive outputs using one or more generative or analytical models informed by the retrieved relevant thoughts;
generate new thoughts derived from analyzing the plurality of events, the new thoughts being stored as vector representations in the thought cache;
compute a curvature metric for one or more regions of the latent-space data structure, the curvature metric comprising a deviation or distortion measure computed from two or more distance or similarity metrics associated with thought representations;
store, in one or more reservoir data structures, compressed representations derived at least in part from the curvature metric;
enter one or more processor-executed cognitive maintenance modes during which the system performs operations comprising transferring curvature-derived data between the thought cache and the one or more reservoir data structures; and
maintain continuity of cognition across inactive intervals and system restarts by persisting at least the thought cache, the one or more reservoir data structures, and associated state data sufficient to restore the cognitive state.

2. The computer system of claim 1, wherein the software instructions further comprise instructions that detect cyclic inference sequences within the latent-space data structure and compute, for each detected cyclic sequence, a loop-derived invariant representing accumulated structural information from the sequence, the loop-derived invariant being stored in a holonomy register and used to inform subsequent thought retrieval or cognitive output generation.

3. The computer system of claim 1, wherein the one or more reservoir data structures comprise a plurality of reservoirs, each reservoir configured to receive and store compressed representations associated with a respective category of curvature-derived data, and wherein the system routes curvature-derived data to a selected reservoir based on a classification of the curvature metric.

4. The computer system of claim 1, wherein the software instructions further comprise instructions that dynamically manage a topology of cognitive sectors within the latent-space data structure, each cognitive sector comprising a logical partition of the thought cache, and wherein managing the topology comprises at least one of creating a new cognitive sector responsive to curvature accumulation in a region, federating two or more cognitive sectors responsive to detected correlation between the cognitive sectors, or dissolving a cognitive sector responsive to absorption of curvature-derived data by a reservoir data structure.

5. The computer system of claim 1, wherein the software instructions further comprise instructions that inject, from the one or more reservoir data structures into the thought cache, compressed representations that augment or restructure portions of the latent-space data structure, the injection being triggered during the processor-executed cognitive maintenance modes or responsive to contextual conditions during cognitive processing.

6. The computer system of claim 2, wherein the processor-executed cognitive maintenance modes further comprise operations that stabilize or consolidate the loop-derived invariants stored in the holonomy register, wherein updating the holonomy register is performed using a constant or near-constant number of arithmetic operations regardless of loop length or latent-space data structure size, and wherein the associated state data includes the holonomy register such that loop-derived invariants are restored upon system restart.

7. The computer system of claim 4, wherein the associated state data includes sector topology metadata comprising sector boundaries and relationships between cognitive sectors, such that the topology of cognitive sectors is restored upon system restart.

8. The computer system of claim 1, wherein the curvature metric is computed using a constant or near-constant number of distance or similarity computations regardless of the size of the latent-space data structure, and wherein storing compressed representations in the one or more reservoir data structures is performed as a constant-size update operation.

9. The computer system of claim 3, wherein the plurality of reservoirs includes reservoirs respectively configured to store compressed representations derived from curvature associated with conceptual conflict, curvature associated with representational noise or unstable associations, curvature associated with structural redundancy, and curvature associated with novel or under-constrained regions of the latent-space data structure.

10. A computer-implemented method comprising:
initializing a persistent cognitive system configured to sustain a cognitive state across inactive periods and restarts, the cognitive state comprising stored thought representations organized in one or more thought caches as vector embeddings within a latent-space data structure;
monitoring a plurality of events comprising external stimuli to the persistent cognitive system and thought triggers internal to the persistent cognitive system;
retrieving relevant thoughts from the thought cache based on similarity metrics computed within the latent-space data structure;
generating cognitive outputs using one or more generative or analytical models informed by the retrieved relevant thoughts;
generating new thoughts derived from analyzing the plurality of events, the new thoughts being stored as vector representations in the thought cache;
computing a curvature metric for one or more regions of the latent-space data structure, the curvature metric comprising a deviation or distortion measure computed from two or more distance or similarity metrics associated with thought representations;
storing, in one or more reservoir data structures, compressed representations derived at least in part from the curvature metric;
entering one or more processor-executed cognitive maintenance modes during which the system performs operations comprising transferring curvature-derived data between the thought cache and the one or more reservoir data structures; and
maintaining continuity of cognition across inactive intervals and system restarts by persisting at least the thought cache, the one or more reservoir data structures, and associated state data sufficient to restore the cognitive state.

11. The method of claim 10, further comprising detecting cyclic inference sequences within the latent-space data structure and computing, for each detected cyclic sequence, a loop-derived invariant representing accumulated structural information from the sequence, the loop-derived invariant being stored in a holonomy register and used to inform subsequent thought retrieval or cognitive output generation.

12. The method of claim 10, wherein the one or more reservoir data structures comprise a plurality of reservoirs, each reservoir configured to receive and store compressed representations associated with a respective category of curvature-derived data, and wherein the method further comprises routing curvature-derived data to a selected reservoir based on a classification of the curvature metric.

13. The method of claim 10, further comprising dynamically managing a topology of cognitive sectors within the latent-space data structure, each cognitive sector comprising a logical partition of the thought cache, wherein managing the topology comprises at least one of creating a new cognitive sector responsive to curvature accumulation in a region, federating two or more cognitive sectors responsive to detected correlation between the cognitive sectors, or dissolving a cognitive sector responsive to absorption of curvature-derived data by a reservoir data structure.

14. The method of claim 10, further comprising injecting, from the one or more reservoir data structures into the thought cache, compressed representations that augment or restructure portions of the latent-space data structure, the injection being triggered during the processor-executed cognitive maintenance modes or responsive to contextual conditions during cognitive processing.

15. The method of claim 11, wherein the processor-executed cognitive maintenance modes further comprise operations that stabilize or consolidate the loop-derived invariants stored in the holonomy register, wherein updating the holonomy register is performed using a constant or near-constant number of arithmetic operations regardless of loop length or latent-space data structure size, and wherein the associated state data includes the holonomy register such that loop-derived invariants are restored upon system restart.

16. The method of claim 13, wherein the associated state data includes sector topology metadata comprising sector boundaries and relationships between the cognitive sectors, such that the topology of cognitive sectors is restored upon system restart.

17. The method of claim 10, wherein the curvature metric is computed using a constant or near-constant number of distance or similarity computations regardless of the size of the latent-space data structure, and wherein storing compressed representations in the one or more reservoir data structures is performed as a constant-size update operation.

18. The method of claim 12, wherein the plurality of reservoirs includes reservoirs respectively configured to store compressed representations derived from curvature associated with conceptual conflict, curvature associated with representational noise or unstable associations, curvature associated with structural redundancy, and curvature associated with novel or under-constrained regions of the latent-space data structure.

19. A non-transitory computer-readable storage medium storing instructions that, when executed by one or more processors, cause the one or more processors to:
initialize a persistent cognitive system configured to sustain a cognitive state across inactive periods and restarts, the cognitive state comprising stored thought representations organized in one or more thought caches as vector embeddings within a latent-space data structure;
monitor a plurality of events comprising external stimuli to the persistent cognitive system and thought triggers internal to the persistent cognitive system;
retrieve relevant thoughts from the thought cache based on similarity metrics computed within the latent-space data structure;
generate cognitive outputs using one or more generative or analytical models informed by the retrieved relevant thoughts; generate new thoughts derived from analyzing the plurality of events, the new thoughts being stored as vector representations in the thought cache;
compute a curvature metric for one or more regions of the latent-space data structure, the curvature metric comprising a deviation or distortion measure computed from two or more distance or similarity metrics associated with thought representations; store, in one or more reservoir data structures, compressed representations derived at least in part from the curvature metric;
enter one or more processor-executed cognitive maintenance modes during which the system performs operations comprising transferring curvature-derived data between the thought cache and the one or more reservoir data structures; and
maintain continuity of cognition across inactive intervals and system restarts by persisting at least the thought cache, the one or more reservoir data structures, and associated state data sufficient to restore the cognitive state.

20. The non-transitory computer-readable storage medium of claim 19, wherein the instructions further cause the one or more processors to detect cyclic inference sequences within the latent-space data structure and compute, for each detected cyclic sequence, a loop-derived invariant representing accumulated structural information from the sequence, the loop-derived invariant being stored in a holonomy register and used to inform subsequent thought retrieval or cognitive output generation.

21. The non-transitory computer-readable storage medium of claim 19, wherein the one or more reservoir data structures comprise a plurality of reservoirs, each reservoir configured to receive and store compressed representations associated with a respective category of curvature-derived data, and wherein the instructions further cause the one or more processors to route curvature-derived data to a selected reservoir based on a classification of the curvature metric.

22. The non-transitory computer-readable storage medium of claim 19, wherein the instructions further cause the one or more processors to dynamically manage a topology of cognitive sectors within the latent-space data structure, each cognitive sector comprising a logical partition of the thought cache, wherein managing the topology comprises at least one of creating a new cognitive sector responsive to curvature accumulation in a region, federating two or more cognitive sectors responsive to detected correlation between the cognitive sectors, or dissolving a cognitive sector responsive to absorption of curvature-derived data by a reservoir data structure.

23. The non-transitory computer-readable storage medium of claim 19, wherein the instructions further cause the one or more processors to inject, from the one or more reservoir data structures into the thought cache, compressed representations that augment or restructure portions of the latent-space data structure, the injection being triggered during the processor-executed cognitive maintenance modes or responsive to contextual conditions during cognitive processing.

24. The non-transitory computer-readable storage medium of claim 20, wherein the processor-executed cognitive maintenance modes further comprise operations that stabilize or consolidate the loop-derived invariants stored in the holonomy register, wherein updating the holonomy register is performed using a constant or near-constant number of arithmetic operations regardless of loop length or latent-space data structure size, and wherein the associated state data includes the holonomy register such that loop-derived invariants are restored upon system restart.

25. The non-transitory computer-readable storage medium of claim 22, wherein the associated state data includes sector topology metadata comprising sector boundaries and relationships between the cognitive sectors, such that the topology of cognitive sectors is restored upon system restart.

26. The non-transitory computer-readable storage medium of claim 19, wherein the curvature metric is computed using a constant or near-constant number of distance or similarity computations regardless of the size of the latent-space data structure, and wherein storing compressed representations in the one or more reservoir data structures is performed as a constant-size update operation.

27. The non-transitory computer-readable storage medium of claim 21 wherein the plurality of reservoirs includes reservoirs respectively configured to store compressed representations derived from curvature associated with conceptual conflict, curvature associated with representational noise or unstable associations, curvature associated with structural redundancy, and curvature associated with novel or under-constrained regions of the latent-space data structure.
